(19) United States
(12) Patent Application Publication
(10) Pub. No.: US 2024/0259069 A1
(43) Pub. Date: Aug. 1, 2024

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/633,497

(22) Filed: Apr. 11, 2024

Related U.S. Application Data
(63) Continuation of application No. PCT/CN2022/124564, filed on Oct. 11, 2022.

(30) Foreign Application Priority Data
Oct. 12, 2021 (CN) 202111184690.7

(51) Int. Cl. H04B 7/06; H04B 7/0456

(52) U.S. Cl. CPC H04B 7/0626; H04B 7/0481

(57) ABSTRACT

A first node receives N CSI configuration information; updates a CSI reporting in a first CSI reporting subset; transmits a first information block; the N CSI configuration information is respectively used to determine N CSI reportings, and the first CSI reporting subset is a subset of the N CSI reportings; the first information block comprises at least one CSI reporting of the N CSI reportings; any Type I CSI reporting in the N CSI reportings corresponds to a first-type integer, and any Type II CSI reporting in the N CSI reportings corresponds to a second-type integer, the N CSI reportings respectively correspond to N priorities, and the N priorities are used to determine a number of CSI reporting(s) comprised in the first CSI reporting subset. The above method configures different processing units for CSI reportings with different CSI computing power requirements, thus avoiding the waste of computing power.

### CROSS REFERENCE TO RELATED APPLICATIONS

This application is the continuation of the international patent application No. PCT/CN2022/124564, filed on Oct. 11, 2022, and claims the priority benefit of Chinese Patent Application No. 202111184690.7, filed on Oct, 12, 2021, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

Multi-antenna technology is a key technique in both 3rd Generation Partner Project (3GPP) Long-term Evolution (LTE) and New Radio (NR) systems. By configuring multiple antennas at a communication node, for instance, at a base station or a User Equipment (UE) to acquire extra spatial degrees of freedom. Multiple antennas are processed by pre-coding and/or beamforming to form a beam pointing in a specific direction to improve communication quality. In downlink multi-antenna transmission, a User Equipment (UE) usually needs to provide feedback on Channel State Information (CSI) to assist the base station in executing precoding and/or beamforming. With the increase of number of antennas, the cost of CSI feedback also increases. And various enhanced multi-antenna technologies, such as the application of multi-user MIMO, require higher feedback accuracy, thus further increasing feedback overhead.

In 3GPP RAN #88e-th meeting and 3GPP R (release) 18 workshop, the application of Machine Learning (ML)/Artificial Intelligence (AI) in the physical layer of wireless communication systems has received widespread attention and discussion. The use of ML/AI technology to compress CSI while addressing the accuracy and overhead of CSI feedback is widely considered one of the important applications of ML/AI at the physical layer.

### SUMMARY

In NR R (release) 15 and R16, the CSI calculation capability that the UE is able to perform simultaneously was introduced to determine the number of CSI reportings that the UE is able to update simultaneously. The applicant found through researches that there is a significant difference between ML/AI-based CSI calculations and traditional CSI calculations, as the two require different computing power. Therefore, when ML/AI-based CSI feedback techniques are introduced, the question of how the UE will determine the number of CSI reportings that can be updated at the same time is one that needs to be addressed. In this case, the question of how to avoid waste of computing power also needs to be addressed.

To address the above problem, the present application provides a solution. It should be noted that although the above description takes the cellular network as an example, the application is also applicable to other scenarios, such as Vehicle-to-Everything (V2X) and sidelink transmission, where similar technical effects can be achieved. Besides, a unified solution for different scenarios (including but not limited to cellular networks, V2X and sidelink transmission) can also help reduce hardware complexity and cost. If no conflict is incurred, embodiments in a first node in the present application and the characteristics of the embodiments are also applicable to a second node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving N CSI configuration information, the N CSI configuration information being respectively used to determine N CSI reportings, the N CSI reportings not occupying a first-type processing unit and a second-type processing unit before a first symbol, N being a positive integer greater than 1;

updating a CSI reporting in a first CSI reporting subset, the first CSI reporting subset being a subset of the N CSI reportings; and

transmitting a first information block, the first information block comprising at least one CSI reporting of the N CSI reportings;

herein, any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; the first node determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

In one embodiment, a problem to be solved in the present application comprises: when the UE is configured with two types of CSI reportings with different CSI computing capacity requirements, how will the UE determine a number of CSI reportings that can be updated simultaneously. The above method solves this problem by using two types of different processing units to handle the two types of CSI reportings separately.

In one embodiment, a problem to be solved in the present application comprises: how to avoid the waste of computing power when the UE is configured with two types of CSI reportings with different CSI computing power requirements. The above method solves this problem by using two different types of processing units to handle the two types of CSI reportings separately.

In one embodiment, characteristics of the above method comprise: the Type I CSI reporting and the Type II CSI reporting require different CSI computing power, and the first-type processing unit and the second-type processing unit respectively provide a CSI computing power required for the Type I CSI reporting and a CSI computing power required for the Type II CSI reporting.

In one embodiment, advantages of the above method comprise: the problem of determining a number of CSI reportings that can be updated simultaneously when the UE is configured with two types of CSI reportings that have different CSI computing power requirements is addressed.

In one embodiment, advantages of the above method comprise: configuring different processing units for CSI reportings with different CSI computing power requirements, thus avoiding the waste of computing power.

According to one aspect of the present application, it is characterized in that the first CSI reporting subset comprises a first reporting subgroup and a second reporting subgroup; the first reporting subgroup comprises each Type I CSI reporting in first M1 CSI reporting(s) in the N CSI reportings. M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

According to one aspect of the present application, it is characterized in that at least one Type II CSI reporting in the N CSI reportings corresponds to a first-type integer; the first reference CSI reporting subset also comprises each Type II CSI reporting corresponding to one first-type integer in the first N1 CSI reporting(s) in the N CSI reportings; the second condition set also comprises a third condition, the third condition comprises that a sum of the first-type integer(s) corresponding to all CSI reporting(s) in a third reference CSI reporting subset is not greater than the first reference threshold, and the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings.

According to one aspect of the present application, it is characterized in that the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings.

According to one aspect of the present application, it is characterized in that at least one Type II CSI reporting in the N CSI reportings corresponds to a first-type integer; the fourth reference CSI reporting subset also comprises each Type II CSI reporting corresponding to one first-type integer in the first N3 CSI reporting(s) in the N CSI reportings.

According to one aspect of the present application, comprising:

transmitting a second information block;

herein, the second information block indicates a first threshold and a second threshold; the first reference threshold is equal to a difference of the first threshold and a first integer, and the first integer is a number of first-type processing unit(s) already occupied in the first symbol; the second reference threshold is equal to a difference of the second threshold and a second integer, and the second integer is a number of second-type processing unit(s) already occupied in the first symbol.

According to one aspect of the present application, it is characterized in that the first information block comprises a first CSI reporting, and the first CSI reporting is a Type II CSI reporting in the first CSI reporting subset; the first CSI reporting comprises a first compressed CSI, and a first pre-compressed CSI used as an input to a first function is used to generate the first compressed CSI.

According to one aspect of the present application, it is characterized in that the first node is a UE.

According to one aspect of the present application, it is characterized in that the first node is a relay node.

The present application provides a method in a second node for wireless communications, comprising:

transmitting N CSI configuration information, the N CSI configuration information being respectively used to determine N CSI reportings, the N CSI reportings not occupying a first-type processing unit and a second-type processing unit before a first symbol, N being a positive integer greater than 1; and

receiving a first information block, the first information block comprising at least one CSI reporting of the N CSI reportings:

herein, any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; a transmitter of the first information block updates a CSI reporting in a first CSI reporting subset, the first CSI reporting subset is a subset of the N CSI reportings; the transmitter of the first information block determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

According to one aspect of the present application, it is characterized in that the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

According to one aspect of the present application, it is characterized in that at least one Type II CSI reporting in the N CSI reportings corresponds to a first-type integer; the first reference CSI reporting subset also comprises each Type II CSI reporting corresponding to one first-type integer in the first N1 CSI reporting(s) in the N CSI reportings; the second condition set also comprises a third condition, the third condition comprises that a sum of the first-type integer(s) corresponding to all CSI reporting(s) in a third reference CSI reporting subset is not greater than the first reference threshold, and the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings.

According to one aspect of the present application, it is characterized in that the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings.

According to one aspect of the present application, it is characterized in that at least one Type II CSI reporting in the N CSI reportings corresponds to a first-type integer; the fourth reference CSI reporting subset also comprises each Type II CSI reporting corresponding to one first-type integer in the first N3 CSI reporting(s) in the N CSI reportings;

According to one aspect of the present application, comprising:

receiving a second information block;

herein, the second information block indicates a first threshold and a second threshold; the first reference threshold is equal to a difference of the first threshold and a first integer, and the first integer is a number of first-type processing unit(s) already occupied in the first symbol; the second reference threshold is equal to a difference of the second threshold and a second integer, and the second integer is a number of second-type processing unit(s) already occupied in the first symbol.

According to one aspect of the present application, it is characterized in that the first information block comprises a first CSI reporting, and the first CSI reporting is a Type II CSI reporting in the first CSI reporting subset; the first CSI reporting comprises a first compressed CSI, and a first pre-compressed CSI used as an input to a first function is used to generate the first compressed CSI.

According to one aspect of the present application, it is characterized in that the second node is a base station.

According to one aspect of the present application, it is characterized in that the second node is a UE.

According to one aspect of the present application, it is characterized in that the second node is a relay node.

The present application provides a first node for wireless communication, comprising:

a first receiver, receiving N CSI configuration information, the N CSI configuration information being respectively used to determine N CSI reportings, the N CSI reportings not occupying a first-type processing unit and a second-type processing unit before a first symbol, N being a positive integer greater than 1;

a first processor, updating a CSI reporting in a first CSI reporting subset, the first CSI reporting subset being a subset of the N CSI reportings; and

a first transmitter, transmitting a first information block, the first information block comprising at least one CSI reporting of the N CSI reportings;

herein, any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; the first node determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

The present application provides a second node for wireless communications, comprising:

a second transmitter, transmitting N CSI configuration information, the N CSI configuration information being respectively used to determine N CSI reportings, the N CSI reportings not occupying a first-type processing unit and a second-type processing unit before a first symbol, N being a positive integer greater than 1; and

a second receiver, receiving a first information block, the first information block comprising at least one CSI reporting of the N CSI reportings;

herein, any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; a transmitter of the first information block updates a CSI reporting in a first CSI reporting subset, the first CSI reporting subset is a subset of the N CSI reportings; the transmitter of the first information block determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

In one embodiment, the present application has the following advantages over conventional schemes:

the problem of how to determine a number of CSI reportings that can be updated simultaneously when the UE is configured with two types of CSI reportings that have different CSI computing power requirements is addressed.

configuring different processing units for CSI reportings with different CSI computing power requirements, so as to avoid the waste of computing power.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of N CSI configuration information, a first CSI reporting subset and a first information block according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of wireless communications according to one embodiment of the present application;

FIG. 6 illustrates a schematic diagram of N priorities being used to determine a number of CSI reporting(s) comprised in a first CSI reporting subset according to one embodiment of the present application;

FIG. 7 illustrates a schematic diagram of N priorities being used to determine a number of CSI reporting(s) comprised in a first CSI reporting subset according to one embodiment of the present application;

FIG. 8 illustrates a schematic diagram of N priorities being used to determine a number of CSI reporting(s) comprised in a first CSI reporting subset according to one embodiment of the present application;

FIG. 9 illustrates a schematic diagram of N priorities being used to determine a number of CSI reporting(s) comprised in a first CSI reporting subset according to one embodiment of the present application;

FIG. 10 illustrates a schematic diagram of N priorities being used to determine a number of CSI reporting(s) comprised in a first CSI reporting subset according to one embodiment of the present application;

FIG. 11 illustrates a schematic diagram of N priorities being used to determine a number of CSI reporting(s) comprised in a first CSI reporting subset according to one embodiment of the present application;

FIG. 12 illustrates a schematic diagram of N priorities being used to determine a number of CSI reporting(s) comprised in a first CSI reporting subset according to one embodiment of the present application;

FIG. 13 illustrates a schematic diagram of N priorities being used to determine a number of CSI reporting(s) comprised in a first CSI reporting subset according to one embodiment of the present application;

FIG. 14 illustrates a schematic diagram of N priorities being used to determine a number of CSI reporting(s) comprised in a first CSI reporting subset according to one embodiment of the present application;

FIG. 15 illustrates a schematic diagram of whether a Type II CSI reporting corresponds to a first-type integer according to one embodiment of the present application;

FIG. 16 illustrates a schematic diagram of a first reference threshold, a second reference threshold, a first threshold and a second threshold according to one embodiment of the present application;

FIG. 17 illustrates a schematic diagram of a relation between a first pre-compressed CSI and a first compressed CSI according to one embodiment of the present application;

FIG. 18 illustrates a schematic diagram of a first compressed CSI according to one embodiment of the present application;

FIG. 19 illustrates a schematic diagram of a first node obtaining a channel measurement used for generating a first pre-compressed CSI based on a reference signal received in a first reference signal resource according to one embodiment of the present application;

FIG. 20 illustrates a structure block diagram of a processor in a first node according to one embodiment of the present application;

FIG. 21 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of N CSI configuration information, a first CSI reporting subset and a first information block according to one embodiment of the present application, as shown in FIG. 1. In 100 illustrated by FIG. 1, each box represents a step. And in particular, the order of steps in boxes does not represent a specific chronological order between the steps.

In Embodiment 1, the first node in the present application receives N CSI configuration information in step 101; updates a CSI reporting in a first CSI reporting subset in step 102; transmits a first information block in step 103; herein, the N CSI configuration information is respectively used to determine N CSI reportings, the N CSI reportings do not occupy a first-type processing unit and a second-type processing unit before a first symbol, N being a positive integer greater than 1; the first CSI reporting subset is a subset of the N CSI reportings; the first information block comprises at least one CSI reporting of the N CSI reportings; any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; the first node determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

In one embodiment, the CSI refers to: Channel State Information.

In one embodiment, the CSI comprises a channel matrix.

In one embodiment, the CSI comprises information of a channel matrix.

In one embodiment, the CSI comprises amplitude and phase information of elements in a channel matrix.

In one embodiment, the N CSI configuration information is respectively carried by a higher-layer signaling.

In one embodiment, the N CSI configuration information is respectively carried by an RRC (Radio Resource Control) signaling.

In one embodiment, the N CSI configuration information is respectively carried by a Medium Access Control layer Control Element (MAC CE) signaling.

In one embodiment, the N CSI configuration information is respectively carried by an RRC signaling and a MAC CE signaling together.

In one embodiment, the N CSI configuration information is respectively carried by N different RRC signalings.

In one embodiment, the N CSI configuration information is carried by a same RRC signaling.

In one embodiment, any of the N CSI configuration information is carried by an IE (Information Element).

In one subembodiment of the above embodiment, a name of the IE comprises “CSI”.

In one subembodiment of the above embodiment, a name of the IE comprises “CSI-Report”.

In one subembodiment of the above embodiment, a name of the IE comprises “CSI-ReportConfig”.

In one embodiment, the N CSI configuration information is respectively carried by N different IEs.

In one embodiment, the N CSI configuration information is carried by a same IE.

In one embodiment, the N CSI configuration information is carried by N different fields of a same IE.

In one embodiment, there exist two CSI configuration information in the N CSI configuration information being carried by a same IE.

In one embodiment, there exist two CSI configuration information in the N CSI configuration information being carried by different IEs.

In one embodiment, there exists a reportConfigType indicated by one of the N CSI configuration information being periodic.

In one embodiment, there exists a reportConfigType indicated by one of the N CSI configuration information being semi-persistent.

In one embodiment, there exists a reportConfigType indicated by one of the N CSI configuration information being aperiodic.

In one embodiment, the N CSI configuration information respectively comprises N first-type higher-layer parameters, and a name of the first-type higher-layer parameter comprises “resourcesForChannelMeasurement”; the first node obtains a channel measurement used for calculating the N CSI reportings respectively based on reference signal resources indicated by the N first-type higher-layer parameters.

In one embodiment, the N CSI configuration information respectively indicates N reference signal resource sets, and the first node obtains a channel measurement used for calculating N CSI reportings based on the N reference signal resource sets.

In one embodiment, any of the N reference signal resource sets comprises either a CSI-RS resource set or a CSI-SSB resource set.

In one embodiment, any of the N reference signal resource sets comprises at least one reference signal resource; any of the N reference signal resource sets comprises CSI-RS (Channel State Information Reference Signal) resources or SS (Synchronization Signal)/PBCH (Physical Broadcast Channel) Block resources.

In one subembodiment of the above embodiment, any of the N reference signal resource sets is a CSI-RS resource or an SS/PBCH Block resource.

In one embodiment, the reference signal resource comprises a CSI-RS port.

In one embodiment, the reference signal resource comprises an antenna port.

In one embodiment, the reference signal resource comprises a reference signal port.

In one embodiment, the N CSI configuration information comprises N third-type higher-layer parameters, and a name of the third-type higher-layer parameter comprises “ResourcesForInteraction”; the first node obtains an interference measurement used for calculating N CSI reportings based on resources indicated by the N third-type higher-layer parameters.

In one embodiment, any of the N CSI reportings comprises one or multiple CSI reporting quantities.

In one embodiment, there exists one of the N CSI reportings comprising one or multiple CSI reporting quantities.

In one embodiment, there exists one of the N CSI reportings not comprising a CSI reporting quantity.

In one embodiment, the N CSI configuration information indicates whether the N CSI reportings comprises a CSI reporting quantity.

In one embodiment, for any CSI reporting in the N CSI reportings, CSI configuration information corresponding to the any CSI reporting indicates whether the any CSI reporting comprises a CSI reporting quantity, or indicates that the any CSI reporting comprises types of one or multiple CSI reporting quantities.

In one embodiment, the N CSI configuration information respectively indicate types of one or multiple CSI reportings comprised in the N CSI reportings.

In one embodiment, the N CSI configuration information respectively comprises N second-type higher-layer parameters, and a name of the second-type higher-layer parameter comprises “reportQuantity”; the N second-type higher-layer parameters correspond one-to-one with the N CSI reportings, and the N second-type higher-layer parameters are respectively used to determine a CSI reporting quantity comprised in a corresponding CSI reporting.

In one subembodiment of the above embodiment, the N second-type higher-layer parameters respectively indicate types of one or multiple CSI reportings comprised in the N CSI reportings.

In one subembodiment of the above embodiment, any of the N second-type higher-layer parameters indicates whether a corresponding CSI reporting comprises a CSI reporting quantity or indicates types of one or more CSI reporting quantities comprised in a corresponding CSI reporting.

In one embodiment, a type of any CSI reporting quantity comprised in any of the N CSI reportings is one type in a first type set.

In one embodiment, the first type set comprises one or more of compressed CSI, CQI (Channel Quality Indicator), PMI (Precoding Matrix Indicator), CRI (CSI-RS Resource Indicator), LI (Layer Indicator), RI (Rank Indicator), SSBRI (SS/PBCH Block Resource Indicator). L1-RSRP (Layer 1 Reference Signal received power), or L1-SINR (Signal to Interference and Noise Ratio).

In one embodiment, the compressed CSI comprises one or more of a compressed PMI, a compressed channel matrix, compressed channel matrix information, a compressed channel covariance matrix, and compressed channel covariance matrix information.

In one embodiment, the first type set comprises one or more of statistical information of channel information, interference information, statistical information of interference information, worst one or more CQIs, and CSIs based on a worst interference measurement.

In one subembodiment of the above embodiment, statistical information of the channel information comprises one or more of a mean of SINR, a variance of SINR, a mean of CQI, or a variance of CQI.

In one subembodiment of the above embodiment, statistical information of the interference information comprises one or more of a mean of the interference, a variance of the interference, or a covariance matrix of interference.

In one embodiment, the N CSI configuration information is respectively used to determine time-frequency resources occupied by the N CSI reportings.

In one embodiment, for any of the N CSI configuration information, if a value of a higher-layer parameter “reportConfigType” of the any CSI configuration information is equal to “periodic” or “semiPersistentOnPUCCH”, and the any CSI configuration information indicates PUCCH (Physical Uplink Control Channel) resources occupied by a corresponding CSI reporting.

In one embodiment, any of the N CSI configuration information indicates a value of each higher-layer parameter in a higher-layer parameter group corresponding to a corresponding CSI reporting.

In one embodiment, a higher-layer parameter group corresponding to a CSI reporting comprises part or all of “resourcesForChannelMeasurement”, “csi-IM-ResourcesForInterference”, “nzp-CSI-RS-ResourcesForInterference”, “reportQuantity”, “reportConfigType”, “reportFreqConfiguration”, “timeRestrictionForChannelMeasurements”, “timeRestrictionForInterferenceMeasurements”, “cqi-Table”, “subbandSize”, “codebookConfig”, “groupBasedBeamReporting” or “non-PMI-PortIndication”.

In one embodiment, a CSI reporting corresponding to any of the N CSI configuration information is a CSI reporting determined by the any CSI configuration information in the N CSI reportings.

In one embodiment, the N CSI reportings are generated according to configurations of the N CSI configuration information.

In one embodiment, the N CSI reportings are respectively one CSI reporting for the N CSI configuration information.

In one embodiment, the meaning of the phrase that a CSI reporting for a CSI configuration information comprises: the first node obtains a channel measurement used for calculating the CSI reporting based on one or more reference signal resources indicated by the CSI configuration information.

In one embodiment, the meaning of the phrase that a CSI reporting for a CSI configuration information comprises: the first node obtains an interference measurement used for calculating the CSI reporting based on one or more interference measurement resources indicated by the CSI configuration information.

In one embodiment, the meaning of the phrase that a CSI reporting for a CSI configuration information comprises: the CSI configuration information indicates types of one or more CSI reporting quantities comprised in the CSI reporting.

In one embodiment, the meaning of the phrase that a CSI reporting for a CSI configuration information comprises: the CSI configuration information indicates whether the CSI reporting comprises a CSI reporting or types of one or more CSI reporting quantities comprised in at least one the CSI reporting.

In one embodiment, the meaning of the phrase that a CSI reporting for a CSI configuration information comprises: the CSI configuration information indicates a value of each higher-layer parameter in a higher-layer parameter group corresponding to the CSI reporting.

In one embodiment, the meaning of the phrase that a CSI reporting for a CSI configuration information comprises: the CSI reporting is generated according to configuration of the CSI configuration information.

In one embodiment, the meaning of the phrase that a CSI reporting for a CSI configuration information comprises: the CSI reporting is generated and transmitted according to configuration of the CSI configuration information.

In one embodiment, the N CSI reportings are for a same carrier.

In one embodiment, the N CSI reportings are for a same serving cell.

In one embodiment, a reference signal resource set associated with the N CSI reportings belongs to a same BandWidth Part (BWP).

In one embodiment, there exist two CSI reportings in the N CSI reportings being for different carriers.

In one embodiment, there exist two CSI reportings in the N CSI reportings being for different serving cells.

In one embodiment, there exist reference signal resource sets associated with two of the N CSI reportings belonging to different BWPs.

In one embodiment, a reference signal resource set associated with a CSI reporting is a reference signal resource set used for a channel measurement indicated by CSI configuration information corresponding to the CSI reporting.

In one embodiment, there does not exist a CSI reporting in the N CSI reportings being the Type I CSI reporting and the Type II CSI reporting at the same time.

In one embodiment, a type of any CSI reporting quantity comprised in any Type I CSI reporting in the N CSI reportings belongs to a first-type subset, and the first-type subset comprises a type of at least one CSI reporting quantity.

In one embodiment, the first-type subset comprises CQI, PMI, CRI, LI, RI, SSBRI, L1-RSRP, and L1-SINR.

In one embodiment, a PMI comprised in the first-type subset is a PMI based on Type I single panel codebook, a PMI based on Type I multi-panel codebook, a PMI based on Type II codebook, a PMI based on Type II port selection codebook, a PMI based on enhanced Type II codebook, and a PMI based on enhanced Type II port selection codebook.

In one embodiment, any Type II CSI reporting in the N CSI reportings comprises an AI based CSI reporting.

In one embodiment, any Type II CSI reporting in the N CSI reportings comprises a compressed CSI reporting.

In one embodiment, a type of any CSI reporting quantity comprised in any Type II CSI reporting in the N CSI reportings belongs to a second-type subset; the second-type subset comprises a type of at least one CSI reporting quantity.

In one embodiment, any Type II CSI reporting in the N CSI reportings comprises a CSI reporting quantity with a type belonging to a second-type subset; the second-type subset comprises a type of at least one CSI reporting quantity.

In one embodiment, the second-type subset comprises a compressed CSI.

In one embodiment, there exists a Type II CSI reporting in the N CSI reportings comprising a CSI reporting quantity with a type belonging to the first-type subset.

In one embodiment, a value of a second-type higher-layer parameter corresponding to any Type I CSI reporting in the N CSI reportings belongs to a first parameter value set, and a value of a second-type higher-layer parameter corresponding to any Type II CSI reporting in the N CSI reportings belongs to a second parameter value set; a name of the second-type higher-layer parameter comprises “reportQuantity”; the first parameter value set and the second parameter value set each comprise at least one parameter value.

In one subembodiment of the above embodiment, the first parameter value set comprises “none”, “cir-RI-PMI-CQI”, “cri-RI-i1”, “cri-RI-i1-CQI”, “cri-RI-CQI”, “cri-RSRP”, “cri-SINR”, “ssb-Index-RSRP”, “ssb-Index-SINR”, and “cri-RI-LI-PMI-CQI”.

In one subembodiment of the above embodiment, there does not exist a parameter value belonging to the first parameter value set and the second parameter value set at the same time.

In one embodiment, any Type I CSI reporting in the N CSI reportings is configured with a higher-layer parameter “codebookConfig”, and any Type II CSI reporting in the N CSI reportings is not configured with a higher-layer parameter “codebookConfig”.

In one embodiment, a codebook configured to any Type I CSI reporting in the N CSI reportings belongs to a first codebook set, and a codebook configured to any Type II CSI reporting in the N CSI reportings belongs to a second codebook set; the first codebook set and the second codebook set each comprise at least one codebook.

In one subembodiment of the above embodiment, the first codebook set comprises Type I single panel codebook, Type I multi-panel codebook, Type II codebook, Type II port selection codebook, enhanced Type II codebook, and enhanced Type II port selection codebook.

In one subembodiment of the above embodiment, the second codebook set comprises a compression-based codebook.

In one subembodiment of the above embodiment, there does not exist a codebook belonging to the first codebook set and the second codebook set at the same time.

In one embodiment, the Type I CSI reporting and the Type II CSI reporting require different CSI computing power.

In one embodiment, the first-type processing unit is a CSI processing unit.

In one embodiment, the first-type processing unit is used to process the Type I CSI reporting.

In one embodiment, the first-type processing unit is used to process the Type I CSI reporting and a CSI reporting quantity belonging to a first-type subset in the Type II CSI reporting.

In one embodiment, the second-type processing unit is a CSI processing unit.

In one embodiment, the second-type processing unit is used to process the Type II CSI reporting.

In one embodiment, the second-type processing unit is used to handle a CSI reporting quantity with a type belonging to a second-type subset in the Type II CSI reporting.

In one embodiment, the first-type processing unit and the second-type processing unit have different CSI computing power.

In one embodiment, any of the N CSI reportings does not occupy the first-type processing unit or the second-type processing unit before the first symbol.

In one embodiment, the first symbol is an Orthogonal Frequency Division Multiplexing (OFDM) symbol.

In one embodiment, the first symbol is an SC-FDMA (Single Carrier Frequency Division Multiple Access) symbol.

In one embodiment, the N CSI reportings occupy at least one type of processing unit in both the first-type processing unit and the second-type processing unit starting from the first symbol.

In one embodiment, any Type I CSI reporting in the N CSI reportings, if updated, occupies L1 first-type processing unit(s) starting from the first symbol, L1 being the first-type integer corresponding to the any Type I CSI reporting.

In one embodiment, any Type II CSI reporting in the N CSI reportings, if updated, occupies L2 second-type processing unit(s) starting from the first symbol, and L2 is the second-type integer corresponding to the any Type II CSI reporting.

In one embodiment, the first node updates each CSI reporting in the first CSI reporting subset.

In one embodiment, the first node updates a value of a CSI reporting quantity comprised in each CSI reporting in the first CSI reporting subset.

In one embodiment, the first node determines on its own whether to update a value of a CSI reporting quantity comprised in a CSI reporting not belonging to the first CSI reporting subset in the N CSI reportings.

In one embodiment, any CSI reporting in the first CSI reporting subset is one of the N CSI reportings.

In one embodiment, the first CSI reporting subset comprises at least one CSI reporting in the N CSI reportings.

In one embodiment, the first CSI reporting subset only comprises one of the N CSI reportings.

In one embodiment, the first CSI reporting subset comprises multiple CSI reportings in the N CSI reportings.

In one embodiment, the first CSI reporting subset comprises at least one the Type I CSI reporting.

In one embodiment, the first CSI reporting subset comprises at least one the Type II CSI reporting.

In one embodiment, the first CSI reporting subset comprises only the Type I CSI reporting in the Type I CSI reporting and the Type II CSI reporting.

In one embodiment, the first CSI reporting subset comprises only the Type II CSI reporting in the Type I CSI reporting and the Type II CSI reporting.

In one embodiment, the first CSI reporting subset comprises at least one the Type I CSI reporting and at least one the Type II CSI reporting.

In one embodiment, the meaning of the phrase of updating a CSI reporting comprises: a value of at least one CSI reporting quantity comprised in the CSI reporting is updated compared to a latest CSI reporting earlier than the CSI reporting for same CSI configuration information.

In one subembodiment of the above embodiment, a value of each CSI reporting quantity comprised in the CSI reporting is updated compared to the latest CSI reporting earlier than the CSI reporting for the same CSI configuration information.

In one subembodiment of the above embodiment, the CSI reporting is any CSI reporting in the first CSI reporting subset.

In one subembodiment of the above embodiment, the CSI reporting is any CSI reporting that does not belong to the first CSI reporting subset in the N CSI reportings, but is determined to be updated by the first node.

In one embodiment, the meaning of the phrase of updating a CSI reporting comprises: the CSI reporting is a CSI reporting for CSI configuration information, and a value of at least one CSI reporting quantity comprised in the CSI reporting is updated compared to a latest CSI reporting earlier than the CSI reporting for the CSI configuration information.

In one subembodiment of the above embodiment, a value of each CSI reporting quantity comprised in the CSI reporting is updated compared to a latest CSI reporting earlier than the CSI reporting for the CSI configuration information.

In one subembodiment of the above embodiment, the CSI reporting is any CSI reporting in the first CSI reporting subset.

In one subembodiment of the above embodiment, the CSI reporting is any CSI reporting that does not belong to the first CSI reporting subset in the N CSI reportings, but is determined to be updated by the first node.

In one subembodiment of the above embodiment, the CSI configuration information is CSI configuration information used to determine the CSI reporting in the N CSI configuration information.

In one embodiment, the first information block comprises only one CSI reporting in the N CSI reportings.

In one embodiment, the first information block comprises multiple CSI reportings in the N CSI reportings.

In one embodiment, the first information comprises the N CSI reportings.

In one embodiment, the first information block is carried by a physical-layer signaling.

In one embodiment, the first information block is carried by a MAC CE signaling.

In one embodiment, the first information block comprises a CSI.

In one embodiment, the first information block comprises Uplink control information (UCI).

In one embodiment, there exists one of the N CSI reportings being a Type I CSI reporting.

In one embodiment, there exists one of the N CSI reportings being a Type II CSI reporting.

In one embodiment, the first-type integer is a non-negative integer.

In one embodiment, there exists the first-type integer corresponding to one of the N CSI reportings being equal to 0.

In one embodiment, there exists the first-type integer corresponding to one of the N CSI reportings being greater than 0.

In one embodiment, if the first-type integer corresponding to a Type I CSI reporting in the N CSI reportings is equal to 0, and the Type I CSI reporting, if updated, does not occupy the first-type processing unit.

In one embodiment, a value of the first-type integer corresponding to any Type I CSI reporting in the N CSI reportings is related to at least one of a type of one or more CSI reporting quantities comprised in the any Type I CSI reporting, whether an associated CSI-RS resource set is configured with a higher-layer parameter “trs-Info”, a number of CSI-RS resources comprised in an associated CSI-RS resource set, a number of CSI-RS port(s) for CSI-RS resources in an associated CSI-RS resource set, and a time-domain behavior of the any Type I CSI reporting or frequency-domain granularity.

In one embodiment, the second-type integer is a non-negative integer.

In one embodiment, the second-type integer is a positive integer.

In one embodiment, there exists the second-type integer corresponding to one Type II CSI reporting in the N CSI reportings being equal to 0.

In one embodiment, there exists the second-type integer corresponding to one Type II CSI reporting in the N CSI reportings being greater than 0.

In one embodiment, the second-type integer corresponding to any Type II CSI reporting in the N CSI reportings is greater than 0.

In one embodiment, if the second-type integer corresponding to a Type II CSI reporting in the N CSI reportings is equal to 0, the Type II CSI reporting, if updated, does not occupy the second-type processing unit.

In one embodiment, a value of the second-type integer corresponding to any Type II CSI reporting in the N CSI reportings is related to at least one of a type of one or more CSI reportings comprised in the any Type II CSI reporting, whether an associated CSI-RS resource set is configured with a higher-layer parameter “trs-Info”, a number of CSI-RS resources comprised in an associated CSI-RS resource set, a number of CSI-RS port(s) for CSI-RS resources in an associated CSI-RS resource set, or a time-domain behavior of the any Type II CSI reporting.

In one embodiment, the time-domain behavior comprises periodicity, quasi-static, and aperiodicity.

In one embodiment, any Type II CSI reporting in the N CSI reportings, if updated, does not occupy the first-type processing unit.

In one embodiment, there exists one Type II CSI reporting in the N CSI reportings, if updated, occupying the first-type processing unit.

In one embodiment, the meaning of the phrase of updating a CSI reporting in a first CSI reporting subset comprises: updating each CSI reporting in the first CSI reporting subset.

In one embodiment, the meaning of the phrase of updating a CSI reporting in a first CSI reporting subset comprises: updating at least one CSI reporting in the first CSI reporting subset.

In one embodiment, the meaning of the phrase that the first node independently determines whether to update a CSI reporting not belonging to the first CSI reporting subset in the N CSI reportings comprises: the first node is not required to update a CSI reporting not belonging to the first CSI reporting subset in the N CSI reportings.

In one embodiment, the meaning of the phrase that the first node independently determines whether to update a CSI reporting not belonging to the first CSI reporting subset in the N CSI reportings comprises: a transmitter of the N CSI configuration information does not assume that the first node updates a CSI reporting not belonging to the first CSI reporting subset in the N CSI reportings.

In one embodiment, the first node does not update a CSI reporting not belonging to the first CSI reporting subset in the N CSI reportings.

In one embodiment, the first node updates a CSI reporting not belonging to the first CSI reporting subset in the N CSI reportings.

In one embodiment, the first node does not update part of CSI reportings in CSI reportings not belonging to the first CSI reporting subset in the N CSI reportings, and the first node updates another part of CSI reportings in CSI reportings not belonging to the first CSI reporting subset.

In one embodiment, priorities corresponding to any two CSI reportings in the N CSI reportings are different.

In one embodiment, the N CSI reportings respectively correspond to N priority values, and the N priority values are respectively real numbers; for any two CSI reportings in the N CSI reportings, when a priority value corresponding to one CSI reporting in the any two CSI reportings is lower than a priority value corresponding to the other CSI reporting in any two CSI reportings, a priority value corresponding to the CSI reporting in the any two CSI reportings is higher than a priority corresponding to the other CSI reporting in the any two CSI reportings.

In one subembodiment of the above embodiment, when a priority value corresponding to one CSI reporting in the any two CSI reportings is higher than a priority value corresponding to the other CSI reporting in the any two CSI reportings, a priority corresponding to the CSI reporting in the any two CSI reportings is lower than a priority corresponding to the other CSI reporting in the any two CSI reportings.

In one embodiment, the N priority values are respectively integers.

In one embodiment, the N priority values are respectively positive integers.

In one embodiment, any two of the N priority values are not equal.

In one embodiment, a priority corresponding to any of the N CSI reportings is related to a time-domain behavior of the any CSI reporting, a type of a comprised CSI reporting quantity, a cell index to which it belongs, and a corresponding reporting configuration identifier.

In one subembodiment of the above embodiment, a time-domain behavior of the any CSI reporting, a type of a CSI reporting quantity, a cell index to which it belongs, and a corresponding reporting configuration identifier are used together to calculate a priority value corresponding to the any CSI reporting.

In one embodiment, the N CSI reportings are sequentially arranged according to corresponding priority values in an ascending order.

In one embodiment, the N priorities are used to determine a CSI reporting comprised in the first CSI reporting subset.

In one embodiment, the N priorities are used to determine which CSI reportings in the N CSI reportings are comprised in the first CSI reporting subset.

### Embodiment 2

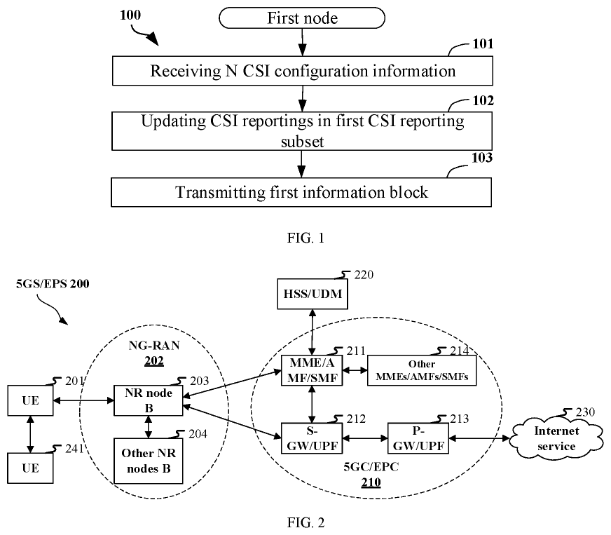

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/ EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

In one embodiment, a radio link between the UE 201 and the gNB 203 is a cellular network link.

In one embodiment, a transmitter of the N CSI configuration information comprises the gNB 203.

In one embodiment, a receiver of the N CSI configuration information comprises the UE 203.

In one embodiment, a transmitter of the first information block comprises the UE 201.

In one embodiment, a receiver of the first information block comprises the gNB 203.

In one embodiment, the UE 201 supports AI-based CSI compression and feedback.

In one embodiment, the UE 201 supports CSI compression and feedback based on Convolutional Neural Networks (CNN).

### Embodiment 3

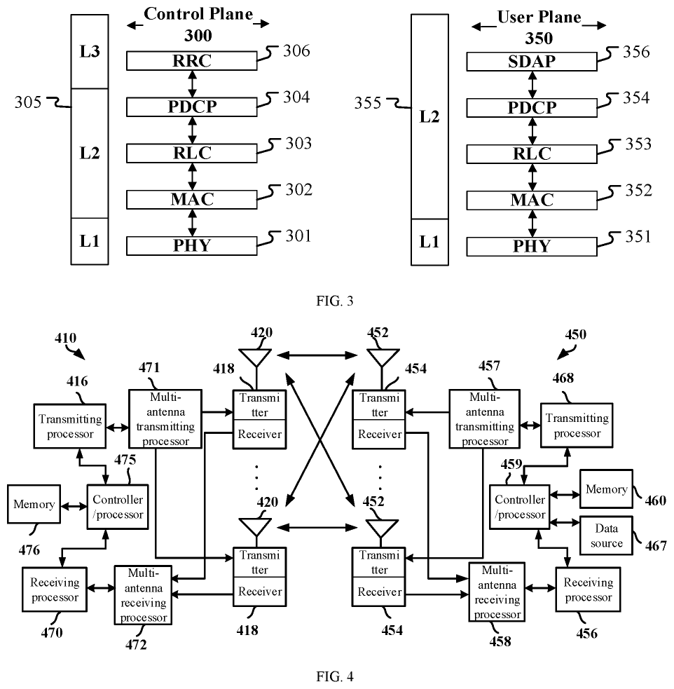

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the N CSI configuration information is generated by the RRC sublayer 306.

In one embodiment, the N CSI configuration information is generated by the MAC sublayer 302, or the MAC sublayer 352.

In one embodiment, a CSI reporting in the first CSI reporting subset is generated by the PHY 301, or the PHY 351.

In one embodiment, the N CSI reportings are generated by the PHY 301, or the PHY 351.

In one embodiment, the first information block is generated by the PHY 301 or the PHY 351.

In one embodiment, the second information block is generated by the RRC sublayer 306.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium, the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least; receives the N CSI configuration information; updates a CSI reporting in the first CSI reporting subset; transmits the first information block.

In one embodiment, the second communication device 450 comprises a memory that stores a computer readable instruction program. The computer readable instruction program generates an action when executed by at least one processor. The action includes; receiving the N CSI configuration information; updating a CSI reporting in the first CSI reporting subset; transmitting the first information block.

In one embodiment, the first communication device 410 comprises at least one processor and at least one memory. The at least one memory comprises computer program codes; the at least one memory and the computer program codes are configured to be used in collaboration with the at least one processor. The first communication device 410 at least; transmits the N CSI configuration information; receives the first information block.

In one embodiment, the first communication device 410 comprises a memory that stores a computer readable instruction program. The computer readable instruction program generates an action when executed by at least one processor. The action includes; transmitting the N CSI configuration information; receiving the first information block.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the N CSI configuration information; at least one of the antenna 420, the transmitter 418, the transmitting processor 416, the multi-antenna transmitting processor 471, the controller/processor 475, or the memory 476 is used to transmit the N CSI configuration information.

In one embodiment, at least one of the antenna 452, the receiver 454, the receiving processor 456, the multi-antenna receiving processor 458, the controller/processor 459, the memory 460, or the data source 467 is used to update a CSI reporting in the first CSI reporting subset.

In one embodiment, at least one of the antenna 420, the receiver 418, the receiving processor 470, the multi-antenna receiving processor 472, the controller/processor 475 or the memory 476 is used to receive the first information block; at least one of the antenna 452, the transmitter 454, the transmitting processor 468, the multi-antenna transmitting processor 457, the controller/processor 459, the memory 460, or the data source 467 is used to transmit the first information block.

In one embodiment, at least one of the antenna 420, the receiver 418, the receiving processor 470, the multi-antenna receiving processor 472, the controller/processor 475 or the memory 476 is used to receive the second information block; at least one of the antenna 452, the transmitter 454, the transmitting processor 468, the multi-antenna transmitting processor 457, the controller/processor 459, the memory 460, or the data source 467 is used to transmit the second information block.

### Embodiment 5

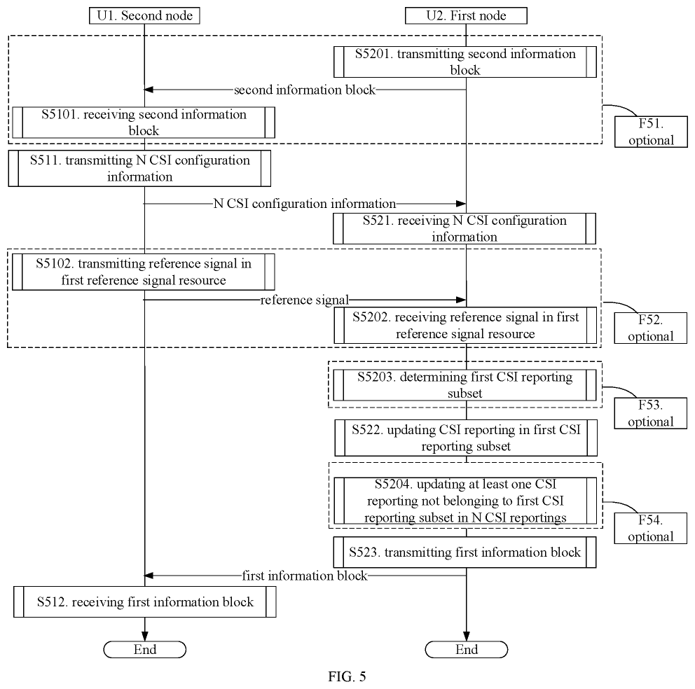

Embodiment 5 illustrates a flowchart of wireless transmission according to one embodiment in the present application, as shown in FIG. 5. In FIG. 5, a second node U1 and a first node U2 are communication nodes transmitted via an air interface. In FIG. 5, steps in F51 to F54 are respectively optional.

The second node U1 receives a second information block in step S5101; transmits N CSI configuration information in step S511; transmits a reference signal in a first reference signal resource in step S5102; receives a first information block in step S512.

The first node U2 transmits a second information block in step S5201; receives N CSI configuration information in step S521; receives a reference signal in a first reference signal resource in step S5202; determines a first CSI reporting subset in step S5203; updates a CSI reporting in the first CSI reporting subset in step S522; updates at least one CSI reporting not belonging to the first CSI reporting subset in N CSI reportings in step S5204; transmits a first information block in step S523.

In embodiment 5, the N CSI configuration information is respectively used by the first node U2 to determine the N CSI reportings, the N CSI reportings do not occupy a first-type processing unit and a second-type processing unit before a first symbol, N being a positive integer greater than 1; the first CSI reporting subset is a subset of the N CSI reportings; the first information block comprises at least one CSI reporting of the N CSI reportings; any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; the first node U2 determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used by the first node U2 to determine a number of CSI reporting(s) comprised in the first CSI reporting subset.

In one embodiment, the first node U2 is the first node in the present application.

In one embodiment, the second node U1 is the second node in the present application.

In one embodiment, an air interface between the second node U1 and the first node U2 comprises a radio interface between a base station and a UE.

In one embodiment, an air interface between the second node U1 and the first node U2 comprises a radio interface between a UE and a UE.

In one embodiment, the second node U1 is a maintenance base station of a serving cell of the first node U2.

In one embodiment, the N CSI configuration information is transmitted in a PDSCH (Physical Downlink Shared Channel).

In one embodiment, the N CSI configuration information is transmitted in a same PDSCH.

In one embodiment, the N CSI configuration information is respectively transmitted in N different PDSCHs.

In one embodiment, there exist two CSI configuration information in the N CSI configuration information being transmitted in a same PDSCH.

In one embodiment, there exist two CSI configuration information in the N CSI configuration information being transmitted in different PDSCHs.

In one embodiment, the first information block is transmitted in a PUCCH.

In one embodiment, the first information block is transmitted in a Physical Uplink Shared Channel (PUSCH).

In one embodiment, a part of the first information block is transmitted in a PUCCH, and another part of the first information block is transmitted in a PUSCH.

In one embodiment, steps in box F51 in FIG. 5 exist; the second information block indicates a first threshold and a second threshold; a first reference threshold is equal to a difference of the first threshold and a first integer, and the first integer is a number of first-type processing unit(s) already occupied in the first symbol; a second reference threshold is equal to a difference of the second threshold and a second integer, and the second integer is a number of second-type processing unit(s) already occupied in the first symbol; the first reference threshold and the second reference threshold are used to determine a number of CSI reporting(s) comprised in the first CSI reporting subset.

In one embodiment, the second information block is carried by an RRC message.

In one embodiment, the second information block is carried by an RRC signaling.

In one embodiment, the second information block is carried by a MAC CE.

In one embodiment, the second information block is carried by an L3 signaling.

In one embodiment, the second information block is carried by UE capability information.

In one embodiment, the second information block comprises information in a UE capability IE.

In one embodiment, the second information block comprises information in a first IE.

In one subembodiment of the above embodiment, a name of the first IE comprises “MIMO-Parameters”.

In one subembodiment of the above embodiment, a name of the first IE comprises “CA-Parameters”.

In one subembodiment of the above embodiment, a name of the first IE comprises “MIMO-ParametersPerBand”.

In one subembodiment of the above embodiment, a name of the first IE comprises “FeatureSetUplink”.

In one embodiment, the second information block is earlier than the N CSI configuration information in time domain.

In one embodiment, the second information block is later than the N CSI configuration information in time domain.

In one embodiment, the second information block is earlier than one of the N CSI configuration information in time domain.

In one embodiment, the second information block is later than one of the N CSI configuration information in time domain.

In one embodiment, the second information block comprises a first field and a second field, and the first field and the second field in the second information block respectively indicate the first threshold and the second threshold.

In one subembodiment of the above embodiment, a value of the first field and a value of the second field in the second information block respectively indicate the first threshold and the second threshold.

In one subembodiment of the above embodiment, a name of the first field comprises “simultaneousCSI-Reports”.

In one embodiment, the second information block is transmitted on a PUSCH.

In one embodiment, steps in the box marked by F52 in FIG. 5 exist; the above method in a first node for wireless communications comprises: receiving a reference signal in a first reference signal resource; herein, the first node obtains a channel measurement used for generating the first pre-compressed CSI based on a reference signal received in the first reference signal resource.

In one embodiment, steps in the box marked by F52 in FIG. 5 exist; the above method in a second node for wireless communications comprises: transmitting a reference signal in a first reference signal resource; herein, the transmitter of the first information block obtains a channel measurement used for generating the first pre-compressed CSI based on a reference signal received in the first reference signal resource.

In one embodiment, the meaning of the phrase of receiving a reference signal in a first reference signal resource comprises: receiving a reference signal transmitted according to configuration information of the first reference signal resource.

In one embodiment, step in box F53 in FIG. 5 exists; the above method in a first node for wireless communications comprises: determining the first CSI reporting subset.

In one embodiment, the first node determines the first CSI reporting subset from the N CSI reportings.

In one embodiment, the first node determines the first CSI reporting subset according to the N priorities.

In one embodiment, the first node determines the first CSI reporting subset according to the N priorities. the first-type integer corresponding to the Type I CSI reporting in the N CSI reportings, as well as the second-type integer corresponding to the Type II CSI reporting in the N CSI reportings.

In one embodiment, the first node determines the first CSI reporting subset according to the N priorities, the first-type integer corresponding to the Type I CSI reporting in the N CSI reportings, the second-type integer corresponding to the Type II CSI reporting in the N CSI reportings, as well as the first-type integer corresponding to the Type II CSI reporting in the N CSI reportings.

In one embodiment, step in box F54 in FIG. 5 exists; the above method in a first node for wireless communications comprises: updating at least one CSI reporting not belonging to the first CSI reporting subset in the N CSI reportings.

In one embodiment, step in box F54 in FIG. 5 does not exist.

### Embodiment 6

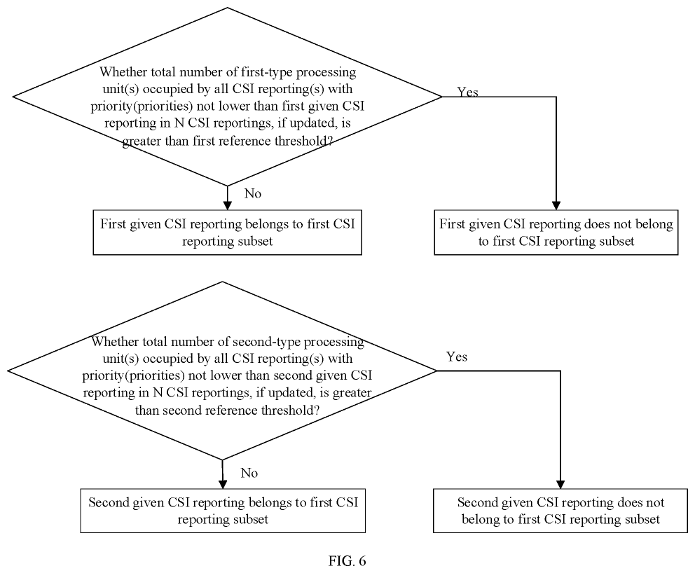

Embodiment 6 illustrates a schematic diagram of N priorities being used to determine a number of CSI reporting(s) comprised in a first CSI reporting subset according to one embodiment of the present application, as shown in FIG. 6. In embodiment 6, a first given CSI reporting is any Type I CSI reporting in the N CSI reportings; if a total number of the first-type processing unit(s) occupied when all CSI reportings with priorities not lower than the first given CSI reporting in the N CSI reportings are updated is not greater than a first reference threshold, the first given CSI reporting belongs to the first CSI reporting subset; if a total number of the first-type processing unit(s) occupied when all CSI reportings with priorities not lower than the first given CSI reporting in the N CSI reportings are updated is greater than the first reference threshold, the first given CSI reporting does not belong to the first CSI reporting subset. A second given CSI reporting is any Type II CSI reporting in the N CSI reportings; if a total number of the second-type processing unit(s) occupied when all CSI reportings with priorities not lower than the second given CSI reporting in the N CSI reportings are updated is not greater than a second reference threshold, the second given CSI reporting belongs to the first CSI reporting subset; if a total number of the second-type processing unit(s) occupied when all CSI reportings with priorities not lower than the second given CSI reporting in the N CSI reportings are updated is greater than the second reference threshold, the second given CSI reporting does not belong to the first CSI reporting subset.

In one embodiment, any Type II CSI reporting in the N CSI reportings, if updated, only occupies the second-type processing unit in the first-type processing unit and the second-type processing unit.

In one embodiment, the all CSI reportings with priorities not lower than the first given CSI reporting in the N CSI reportings comprise the first given CSI reporting, and the all CSI reportings with priorities not lower than the second given CSI reporting in the N CSI reportings comprise the second given CSI reporting.

Embodiment 7

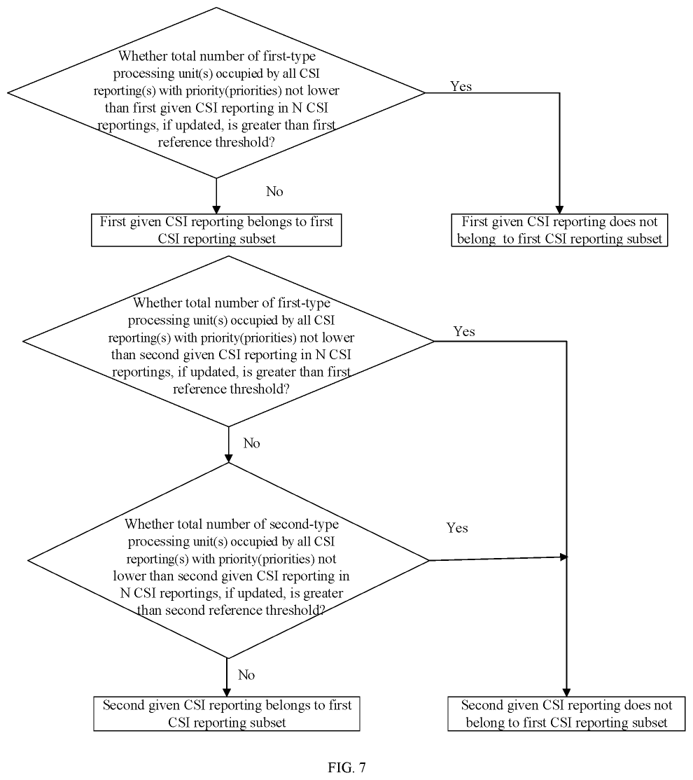

Embodiment 7 illustrates a schematic diagram of N priorities being used to determine a number of CSI reporting(s) comprised in a first CSI reporting subset according to one embodiment of the present application, as shown in FIG. 7. In embodiment 7, a first given CSI reporting is any Type I CSI reporting in the N CSI reportings; if a total number of the first-type processing unit(s) occupied when all CSI reportings with priorities not lower than the first given CSI reporting in the N CSI reportings are updated is not greater than a first reference threshold, the first given CSI reporting belongs to the first CSI reporting subset, and if a total number of the first-type processing unit(s) occupied when all CSI reportings with priorities not lower than the first given CSI reporting in the N CSI reportings is greater than the first reference threshold, the first given CSI reporting does not belong to the first CSI reporting subset; a second given CSI reporting is any Type II CSI reporting in the N CSI reportings; if a total number of the first-type processing unit(s) occupied by when all CSI reportings with priorities not lower than the second given CSI reporting in the N CSI reportings are updated is not greater than a first reference threshold and a total number of second-type processing unit(s) occupied when all CSI reportings with priorities not lower than the second given CSI reporting in the N CSI reportings are updated is not greater than a second reference threshold, the second given CSI reporting belongs to the first CSI reporting subset; if a total number of the first-type processing unit(s) occupied when all CSI reportings with priorities not lower than the second given CSI reporting in the N CSI reportings are updated is greater than the first reference threshold, the second given CSI reporting does not belong to the first CSI reporting subset; if a total number of the second-type processing unit(s) occupied when all CSI reportings with priorities not lower than the second given CSI reporting in the N CSI reportings are updated is greater than the second reference threshold, the second given CSI reporting does not belong to the first CSI reporting subset.

In one embodiment, there exists a Type II CSI reporting in the N CSI reportings, if updated, occupying at least one the first-type processing unit and at least one the second-type processing unit.

In one embodiment, any Type II CSI reporting in the N CSI reportings, if updated, occupying at least one the first-type processing unit and at least one the second-type processing unit.

In one embodiment, the all CSI reportings with priorities not lower than the first given CSI reporting in the N CSI reportings comprise the first given CSI reporting, and the all CSI reportings with priorities not lower than the second given CSI reporting in the N CSI reportings comprise the second given CSI reporting.

In one embodiment, there exists a Type II CSI reporting in all CSI reportings with priorities not lower than the first given CSI reporting in the N CSI reportings, if updated, occupying the first-type processing unit.

In one embodiment, there exists a Type II CSI reporting in all CSI reportings with priorities not lower than the second given CSI reporting in the N CSI reportings, if updated, occupying the first-type processing unit.

### Embodiment 8

Embodiment 8 illustrates a schematic diagram of N priorities being used to determine a number of CSI reporting(s) comprised in a first CSI reporting subset according to one embodiment of the present application, as shown in FIG. 8. In embodiment 8, a first given CSI reporting is any Type I CSI reporting in the N CSI reportings; when the first given CSI reporting is a CSI reporting with highest priority in the N CSI reportings, and if a number of the first-type processing unit(s) occupied when the first given CSI reporting is updated is not greater than a first reference threshold, the first given CSI reporting belongs to the first CSI reporting subset, otherwise the first given CSI reporting does not belong to the first CSI reporting subset; when the first given CSI reporting is not a CSI reporting with highest priority in the N CSI reportings, and a sum of a total number of the first-type processing unit(s) occupied when all CSI reportings with priorities greater than the first given CSI reporting and belonging to the first CSI reporting subset in the N CSI reportings are updated and a number of the first-type processing unit(s) occupied when the first given CSI reporting is updated is not greater than the first reference threshold, the first given CSI reporting belongs to the first CSI reporting subset, otherwise the first given CSI reporting does not belong to the first CSI reporting subset; a second given CSI reporting is any Type II CSI reporting in the N CSI reportings; when the second given CSI reporting is a CSI reporting with highest priority in the N CSI reportings, and if a number of the second-type processing unit(s) occupied when the second given CSI reporting is updated is not greater than a second reference threshold, the second given CSI reporting belongs to the first CSI reporting subset, otherwise the second given CSI reporting does not belong to the first CSI reporting subset; when the second given CSI reporting is not a CSI reporting with highest priority in the N CSI reportings, and if a sum of a number of the second-type processing unit(s) occupied when all CSI reportings with priorities higher than the second given CSI reporting in the N CSI reportings and belonging to the first CSI reporting subset are updated and a number of the second-type processing unit(s) occupied when the second given CSI reporting is updated is not greater than the second reference threshold, the second given CSI reporting belongs to the first CSI reporting subset, otherwise the second given CSI reporting does not belong to the first CSI reporting subset.

In one embodiment, any Type II CSI reporting in the N CSI reportings, if updated, only occupies the second-type processing unit in the first-type processing unit and the second-type processing unit.

In one embodiment, the first given CSI reporting belongs to the first CSI reporting subset, and any CSI reporting with a priority higher than the first given CSI reporting in the N CSI reportings belongs to the first CSI reporting subset.

In one embodiment, the first given CSI reporting belongs to the first CSI reporting subset, and there exists one CSI reporting with a priority higher than the first given CSI reporting in the N CSI reportings not belonging to the first CSI reporting subset.

In one embodiment, the second given CSI reporting belongs to the first CSI reporting subset, and any CSI reporting with priority higher than the second given CSI reporting in the N CSI reportings belongs to the first CSI reporting subset.

In one embodiment, the second given CSI reporting belongs to the first CSI reporting subset, and there exists one CSI reporting with priority higher than the second given CSI reporting in the N CSI reportings not belonging to the first CSI reporting subset.

### Embodiment 9

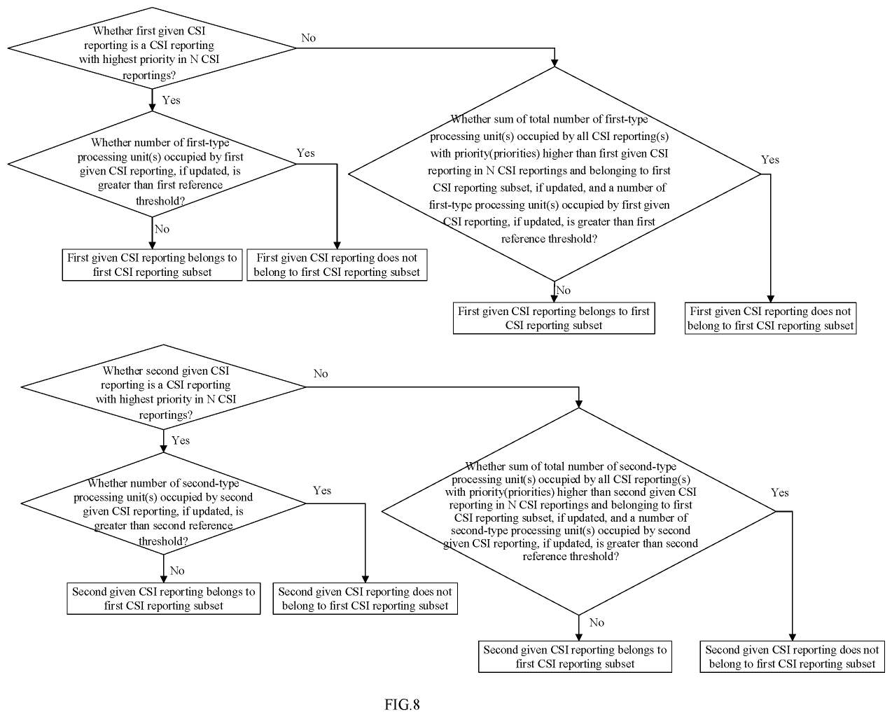

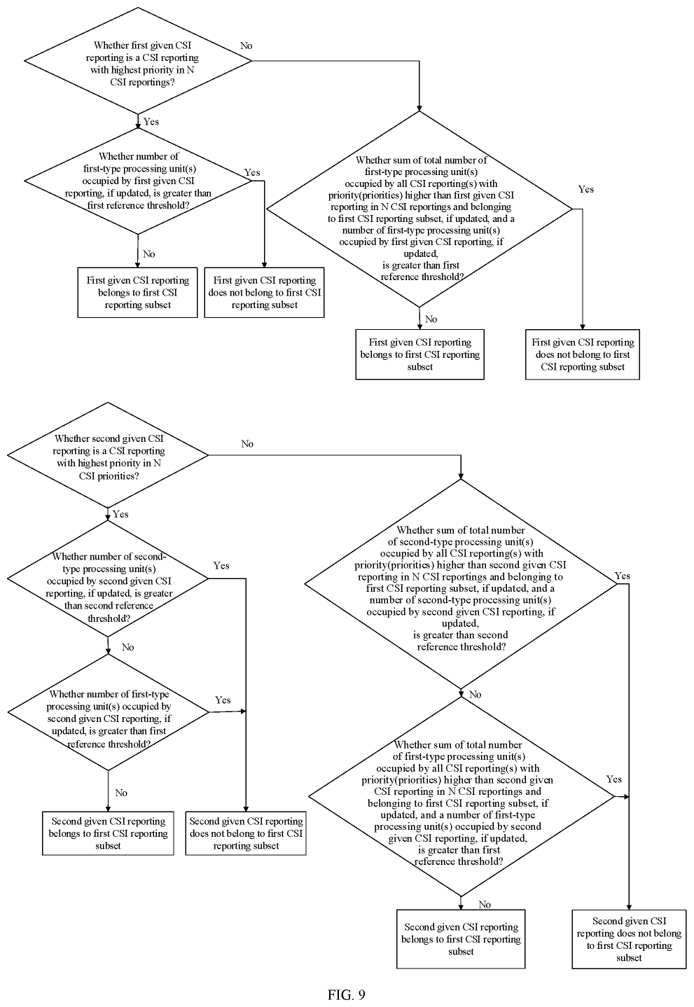

Embodiment 9 illustrates a schematic diagram of N priorities being used to determine a number of CSI reporting(s) comprised in a first CSI reporting subset according to one embodiment of the present application, as shown in FIG. 9. In embodiment 9, a first given CSI reporting is any Type I CSI reporting in the N CSI reportings; when the first given CSI reporting is a CSI reporting with highest priority in the N CSI reportings, and if a number of the first-type processing unit(s) occupied when the first given CSI reporting is updated is not greater than a first reference threshold, the first given CSI reporting belongs to the first CSI reporting subset, otherwise the first given CSI reporting does not belong to the first CSI reporting subset; when the first given CSI reporting is not a CSI reporting with highest priority in the N CSI reportings, and a sum of a total number of the first-type processing unit(s) occupied when all CSI reportings with priorities greater than the first given CSI reporting and belonging to the first CSI reporting subset in the N CSI reportings are updated and a number of the first-type processing unit(s) occupied when the first given CSI reporting is updated is not greater than the first reference threshold, the first given CSI reporting belongs to the first CSI reporting subset, otherwise the first given CSI reporting does not belong to the first CSI reporting subset; a second given CSI reporting is any Type II CSI reporting in the N CSI reportings; when the second given CSI reporting is a CSI reporting with highest priority in the N CSI reportings, and if a number of the second-type processing unit(s) occupied when the second given CSI reporting is updated is not greater than a second reference threshold and a number of the first-type processing unit(s) occupied when the second given CSI reporting is updated is not greater than a first reference threshold, the second given CSI reporting belongs to the first CSI reporting subset, otherwise the second given CSI reporting does not belong to the first CSI reporting subset; when the second given CSI reporting is not a CSI reporting with highest priority in the N CSI reportings, and if a sum of a total number of the second-type processing unit(s) occupied when all CSI reportings with priorities higher than the second given CSI reporting in the N CSI reportings and belonging to the first CSI reporting subset are updated and a number of the second-type processing unit(s) occupied when the second given CSI reporting is updated is not greater than the second reference threshold, and a sum of a total number of first-type processing unit(s) occupied when all CSI reportings with priorities higher than the second given CSI reporting in the N CSI reportings and belonging to the first CSI reporting subset are updated and a number of the first-type processing unit(s) occupied when the second given CSI reporting is updated is not greater than the first reference threshold, the second given CSI reporting belongs to the first CSI reporting subset, otherwise the second given CSI reporting does not belong to the first CSI reporting subset.

In one embodiment, there exists a Type II CSI reporting in the N CSI reportings, if updated, occupying at least one the first-type processing unit and at least one the second-type processing unit.

In one embodiment, any Type II CSI reporting in the N CSI reportings, if updated, occupying at least one the first-type processing unit and at least one the second-type processing unit.

In one embodiment, the second given CSI reporting, if updated, occupies a number of the first-type processing unit(s) equal to zero.

In one embodiment, the second given CSI reporting, if updated, occupies a number of the first-type processing unit(s) greater than zero.

### Embodiment 10

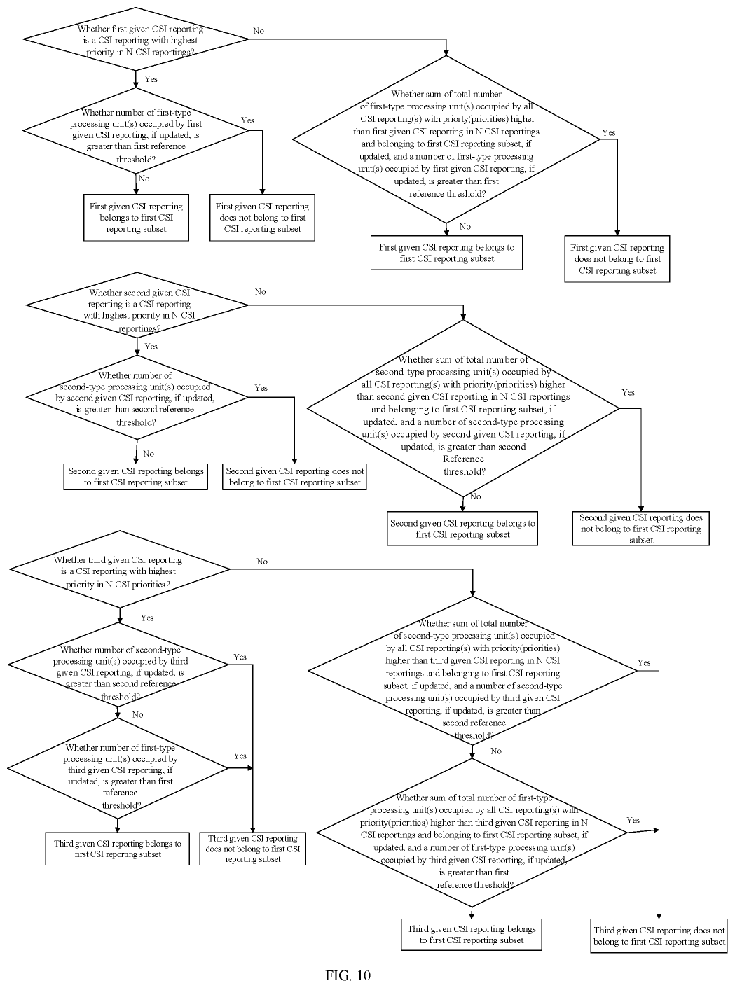

Embodiment 10 illustrates a schematic diagram of N priorities being used to determine a number of CSI reporting(s) comprised in a first CSI reporting subset according to one embodiment of the present application, as shown in FIG. 10. In embodiment 10, a first given CSI reporting is any one of the N CSI reportings, if updated, not occupying the second-type processing unit; when the first given CSI reporting is a CSI reporting with highest priority in the N CSI reportings, and if a number of the first-type processing unit(s) occupied when the first given CSI reporting is updated is not greater than a first reference threshold, the first given CSI reporting belongs to the first CSI reporting subset, otherwise the first given CSI reporting does not belong to the first CSI reporting subset; when the first given CSI reporting is not a CSI reporting with highest priority in the N CSI reportings, and a sum of a total number of the first-type processing unit(s) occupied when all CSI reportings with priorities greater than the first given CSI reporting and belonging to the first CSI reporting subset in the N CSI reportings are updated and a number of the first-type processing unit(s) occupied when the first given CSI reporting is updated is not greater than the first reference threshold, the first given CSI reporting belongs to the first CSI reporting subset, otherwise the first given CSI reporting does not belong to the first CSI reporting subset; a second given CSI reporting is any of the N CSI reportings, if updated, not occupying the first-type processing unit; when the second given CSI reporting is a CSI reporting with highest priority in the N CSI reportings, and if a number of the second-type processing unit(s) occupied when the second given CSI reporting is updated is not greater than a second reference threshold, the second given CSI reporting belongs to the first CSI reporting subset, otherwise the second given CSI reporting does not belong to the first CSI reporting subset; when the second given CSI reporting is not a CSI reporting with highest priority in the N CSI reportings, and if a sum of a total number of the second-type processing unit(s) occupied when all CSI reportings with priorities higher than the second given CSI reporting in the N CSI reportings and belonging to the first CSI reporting subset are updated and a number of the second-type processing unit(s) occupied when the second given CSI reporting is updated is not greater than the second reference threshold, the second given CSI reporting belongs to the first CSI reporting subset, otherwise the second given CSI reporting does not belong to the first CSI reporting subset; a third given CSI reporting is any one of the N CSI reportings, if updated, occupying CSI reportings of at least one the first-type processing unit and at least one the second-type processing unit at the same time; when the third given CSI reporting is a CSI reporting with highest priority in the N CSI reportings, and if a number of the second-type processing unit(s) occupied when the third given CSI reporting is updated is not greater than a second reference threshold and a number of the first-type processing unit(s) occupied when the third given CSI reporting is updated is not greater than a first reference threshold, the third given CSI reporting belongs to the first CSI reporting subset, otherwise the third given CSI reporting does not belong to the first CSI reporting subset; when the third given CSI reporting is not a CSI reporting with highest priority in the N CSI reportings, and if a sum of a total number of the second-type processing unit(s) occupied when all CSI reportings with priorities higher than the third given CSI reporting and belonging to the first CSI reporting subset in the N CSI reportings are updated and a number of the second-type processing unit(s) occupied when the third given CSI reporting is updated is not greater than the second reference threshold, and a sum of a total number of the first-type processing unit(s) occupied when all CSI reportings with priorities higher than the third given CSI reporting and belonging to the first CSI reporting subset in the N CSI reportings are updated and a number of the first-type processing unit(s) occupied when the third given CSI reporting is updated is not greater than the first reference threshold, the third given CSI reporting belongs to the first CSI reporting subset, otherwise the third given CSI reporting does not belong to the first CSI reporting subset.

In one embodiment, there exists a Type II CSI reporting in the N CSI reportings, if updated, occupying at least one the first-type processing unit and at least one the second-type processing unit; there exists one Type II CSI reporting in the N CSI reportings, if updated, not occupying the first-type processing unit.

In one embodiment, the first given CSI reporting is any Type I CSI reporting in the N CSI reportings, the second given CSI reporting is a Type II CSI reporting in the N CSI reportings, and the third CSI reporting is a Type II CSI reporting in the N CSI reportings.

### Embodiment 11

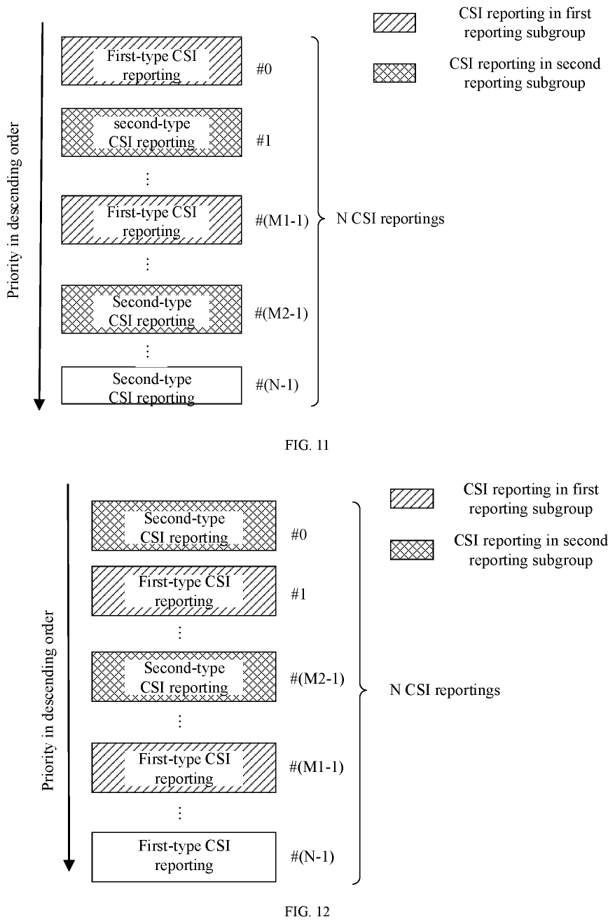

Embodiment 11 illustrates a schematic diagram of N priorities being used to determine a number of CSI reporting(s) comprised in a first CSI reporting subset according to one embodiment of the present application, as shown in FIG. 11. In embodiment 11, the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

In FIG. 11, indexes of the N CSI reportings are respectively #0, . . . , #(N-1); the first M1 CSI reportings are respectively CSI reportings indexed as #0, . . . , #(M1-1), and the first M2 CSI reportings are respectively CSI reportings indexed as #0, . . . , #(M2-1).

In one embodiment, the first CSI reporting subset consists of the first reporting subgroup and the second reporting subgroup.

In one embodiment, the first CSI reporting subgroup comprises at least one Type I CSI reporting in the N CSI reportings.

In one embodiment, any CSI reporting in the first CSI reporting subgroup is a Type I CSI reporting in the N CSI reportings.

In one embodiment, the second CSI reporting subgroup comprises at least one Type II CSI reporting in the N CSI reportings.

In one embodiment, any CSI reporting in the second CSI reporting subgroup is a Type II CSI reporting in the N CSI reportings.

In one embodiment, there exist a CSI reporting subgroup in the first CSI reporting subgroup and the second CSI reporting subgroup being an empty set.

In one embodiment, both the first CSI reporting subgroup and the second CSI reporting subgroup are not empty sets.

In one embodiment, the first reporting subgroup consists of all Type I CSI reportings in the first M1 CSI reporting(s) in the N CSI reportings.

In one embodiment, the first M1 CSI reporting(s) in the N CSI reportings is(are respectively) M1 CSI reporting(s) with highest priority(priorities) in N CSI reportings.

In one embodiment, the first N1 CSI reporting(s) in the N CSI reportings is(are respectively) N1 CSI reporting(s) with highest priority(priorities) in N CSI reportings.

In one embodiment, the second reporting subgroup consists of all Type II CSI reportings in the first M2 CSI reporting(s) in the N CSI reportings.

In one embodiment, the first M2 CSI reporting(s) in the N CSI reportings is(are respectively) M2 CSI reporting(s) with highest priority(priorities) in the N CSI reportings.

In one embodiment, the first N2 CSI reporting(s) in the N CSI reportings is(are respectively) N2 CSI reporting(s) with highest priority(priorities) in the N CSI reportings.

In one embodiment, the first condition only comprises that a sum of the first-type integer corresponding to all CSI reportings in the first reference CSI reporting subset is not greater than the first reference threshold.

In one embodiment, when a sum of the first-type integer(s) corresponding to all CSI reporting(s) in the first reference CSI reporting subset is not greater than the first reference threshold, the first condition is satisfied; when a sum of the first-type integer(s) corresponding to all CSI reporting(s) in the first reference CSI reporting subset is greater than the first reference threshold, the first condition is not satisfied.

In one embodiment, the first reference CSI reporting subset comprises at least one CSI reporting in the N CSI reportings.

In one embodiment, any CSI reporting in the first reference CSI reporting subset is one of the N CSI reportings.

In one embodiment, the first reference CSI reporting subset consists of all Type I CSI reportings in the first N1 CSI reporting(s) in the N CSI reportings.

In one embodiment, the first reference CSI reporting subset comprises at least one CSI reporting other than all Type I CSI reportings in the first N1 CSI reporting(s) in the N CSI reportings.

In one embodiment, any CSI reporting in the first reference CSI reporting subset is a Type I CSI reporting.

In one embodiment, the first reference CSI reporting subset comprises a Type I CSI reporting and a Type II CSI reporting.

In one embodiment, the second condition only comprises that a sum of the second-type integer(s) corresponding to all CSI reporting(s) in the second reference CSI reporting subset is not greater than the second reference threshold.

In one embodiment, when a sum of the second-type integer(s) corresponding to all CSI reporting(s) in the second reference CSI reporting subset is not greater than the second reference threshold, the second condition is satisfied; when a sum of the second-type integer(s) corresponding to all CSI reporting(s) in the second reference CSI reporting subset is greater than the second reference threshold, the second condition is not satisfied.

In one embodiment, the second condition set only comprises the second condition.

In one embodiment, when the second condition is satisfied, the second condition set is satisfied; when the second condition is not satisfied, the second condition set is not satisfied.

In one embodiment, the second reference CSI reporting subset comprises at least one CSI reporting in the N CSI reportings.

In one embodiment, any CSI reporting in the second reference CSI reporting subset is one of the N CSI reportings.

In one embodiment, the second reference CSI reporting subset consists of each Type II CSI reporting in the first N2 CSI reporting(s) in the N CSI reportings.

In one embodiment, the second reference CSI reporting subset comprises at least one CSI reporting other than each Type II CSI reporting in the first N2 CSI reporting(s) in the N CSI reportings.

In one embodiment, any CSI reporting in the second reference CSI reporting subset is a Type II CSI reporting.

In one embodiment, the M1 is greater than the M2.

In one embodiment, the M1 is less than the M2.

In one embodiment, the M1 is equal to the M2.

In one embodiment, the first reference threshold is equal to a difference of a first threshold and a first integer; the first threshold is a number of the first-type processing unit(s) owned by the first node, and the first integer is a number of first-type processing unit(s) already occupied in the first symbol; the second reference threshold is equal to a difference of a second threshold and a second integer, the second threshold is a number of the second-type processing unit(s) owned by the first node, and the second integer is a number of second-type processing unit(s) already occupied in the first symbol.

In one embodiment, a CSI reporting indexed as #0 corresponds to a highest priority in the N CSI reportings. and a CSI reporting indexed as #(N-1) corresponds to a lowest priority in the N CSI reportings.

### Embodiment 12

Embodiment 12 illustrates a schematic diagram of N priorities being used to determine a number of CSI reporting(s) comprised in a first CSI reporting subset according to one embodiment of the present application, as shown in FIG. 12. In embodiment 12, at least one Type II CSI reporting in the N CSI reportings corresponds to a first-type integer; the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings and each Type II CSI reporting corresponding to one first-type integer in the first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition and a third condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings, the third condition comprises that a sum of the first-type integer(s) corresponding to all CSI reporting(s) in a third reference CSI reporting subset is not greater than the first reference threshold, the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings.

In FIG. 12, indexes of the N CSI reportings are respectively #0, . . . , #(N-1); the first M1 CSI reportings are CSI reportings indexed as #0. #(M1-1). and the first M2 CSI reportings are respectively CSI reportings indexed as #0, . . . , #(M2-1).

In one embodiment, for any Type II CSI reporting in the N CSI reportings, and if the any Type II CSI reporting occupies at least one the first-type processing unit when it is updated, the any Type II CSI reporting corresponds to a first-type integer, the any Type II CSI reporting, if updated, occupies a number of the first-type processing unit(s) equal to the corresponding first-type integer; if the any Type II CSI reporting does not occupy the first-type processing unit when it is updated, there does not exist a first-type integer corresponding to the any Type II CSI reporting.

In one embodiment, there exists one Type II CSI reporting in the N CSI reportings not having a corresponding first-type integer.

In one embodiment, any Type II CSI reporting in the N CSI reportings corresponds to a first-type integer.

In one embodiment, any Type II CSI reporting in the N CSI reportings, regardless of whether the first-type processing unit is occupied when it is updated, corresponds to a first-type integer.

In one subembodiment of the above embodiment, if the any Type II CSI reporting occupies at least the first-type processing unit when it is updated, the first-type integer corresponding to the any Type II CSI reporting is greater than 0; if the any Type II CSI reporting does not occupy the first-type processing unit when it is updated, the first-type integer corresponding to the any Type II CSI reporting is equal to 0.

In one embodiment, at least one Type II CSI reporting in the N CSI reportings, if updated, occupies at least one the first-type processing unit.

In one embodiment, any Type II CSI reporting in the N CSI reportings, if updated, occupies at least one the first-type processing unit.

In one embodiment, there exists one Type II CSI reporting in the N CSI reportings, if updated, not occupying the first-type processing unit.

In one embodiment, the first-type integer corresponding to any Type II CSI reporting in the N CSI reportings is a non-negative integer.

In one embodiment, there exists the first-type integer corresponding to a second-type CSI reporting in the N CSI reportings being equal to 0.

In one embodiment, any Type II CSI reporting in the N CSI reportings, if corresponding to one first-type integer, the first-type integer corresponding to the any Type II CSI reporting is greater than 0.

In one embodiment, the first reference CSI reporting subset consists of each Type I CSI reporting in the first N1 CSI reporting(s) in the N CSI reportings and each Type II CSI reporting corresponding to a first-type integer in the first N1 CSI reporting(s) in the N CSI reportings.

In one embodiment, any CSI reporting in the first reference CSI reporting subset corresponds to a first-type integer.

In one embodiment, the first reference CSI reporting subset comprises at least one Type II CSI reporting in the first N1 CSI reporting(s) in the N CSI reportings.

In one embodiment, the first reference CSI reporting subset does not comprise any Type II CSI reporting in the first N1 CSI reporting(s) in the N CSI reportings.

In one embodiment, the first reference CSI reporting subset comprises each Type II CSI reporting in the first N1 CSI reporting(s) in the N CSI reportings.

In one embodiment, the first reference CSI reporting subset comprises only partial Type II CSI reporting(s) in the first N1 CSI reporting(s) in the N CSI reportings.

In one embodiment, the third condition only comprises that a sum of the first-type integer(s) corresponding to all CSI reporting(s) in the third reference CSI reporting subset is not greater than the first reference threshold.

In one embodiment, the second condition set consists of the second condition and the third condition.

In one embodiment, when both the second condition and the third condition are satisfied, the second condition set is satisfied; when the second condition is not satisfied, the second condition set is not satisfied; when the third condition is not satisfied, the second condition set is not satisfied.

In one embodiment, when and only when both the second condition and the third condition are satisfied, the second condition set is satisfied.

In one embodiment, the third reference CSI reporting subset consists of each Type I CSI reporting in the first N2 CSI reporting(s) in the N CSI reportings and each Type II CSI reporting corresponding to one first-type integer in the first N2 CSI reporting(s) in the N CSI reportings.

In one embodiment, any CSI reporting in the third reference CSI reporting subset corresponds to a first-type integer.

In one embodiment, the third reference CSI reporting subset comprises at least one Type II CSI reporting in the first N2 CSI reporting(s) in the N CSI reportings.

In one embodiment, the third reference CSI reporting subset does not comprise any Type II CSI reporting in the first N2 CSI reporting(s) in the N CSI reportings.

In one embodiment, the third reference CSI reporting subset comprises each Type II CSI reporting in the first N2 CSI reporting(s) in the N CSI reportings.

In one embodiment, the third reference CSI reporting subset comprises only partial Type II CSI reporting(s) in the first N2 CSI reporting(s) in the N CSI reportings.

### Embodiment 13

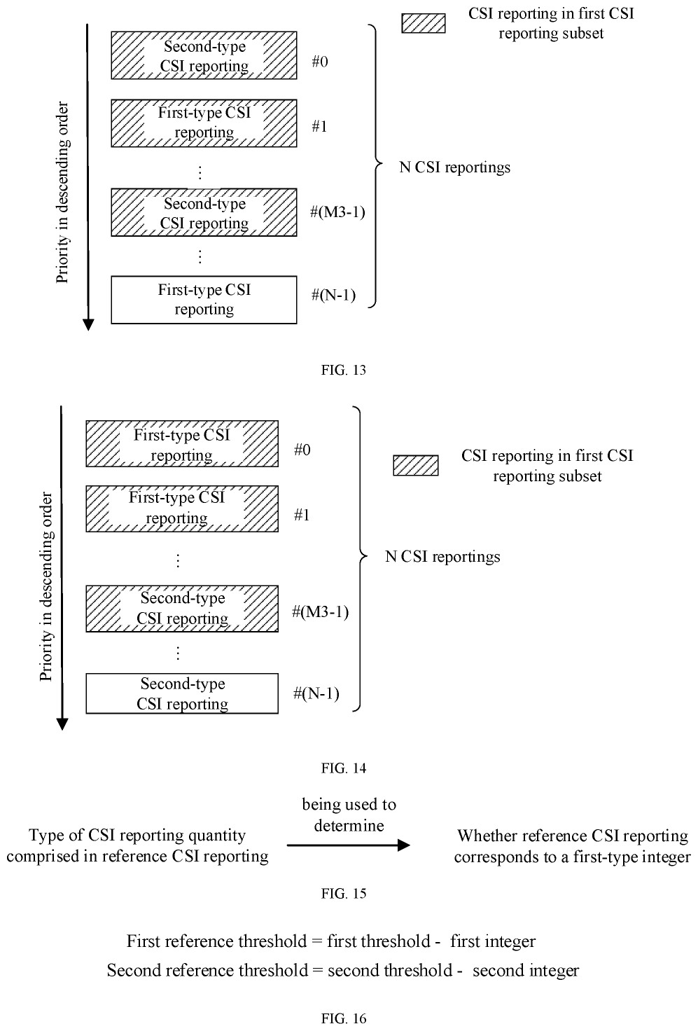

Embodiment 13 illustrates a schematic diagram of N priorities being used to determine a number of CSI reporting(s) comprised in a first CSI reporting subset according to one embodiment of the present application, as shown in FIG. 13. In embodiment 13, the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings. In FIG. 13, indexes of the N CSI reportings are respectively #0, . . . , #(N-1). The first M3 CSI reporting(s) are respectively CSI reportings indexed as #0, . . . , #(M3-1).

In one embodiment, the first M3 CSI reporting(s) in the N CSI reportings is(are respectively) M3 CSI reporting(s) with highest priority (priorities) in N CSI reporting(s).

In one embodiment, the first N3 CSI reporting(s) in the N CSI reportings is(are respectively) N3 CSI reporting(s) with highest priority(priorities) in N CSI reportings.

In one embodiment, the fourth condition only comprises that a sum of the first-type integer(s) corresponding to all CSI reporting(s) in the fourth reference CSI reporting subset is not greater than the first reference threshold.

In one embodiment, the fifth condition only comprises that a sum of the second-type integer(s) corresponding to all CSI reporting(s) in the fifth reference CSI reporting subset is not greater than the second reference threshold.

In one embodiment, any CSI reporting in the fifth reference CSI reporting subset corresponds to a second-type integer.

In one embodiment, the fourth reference CSI reporting subset consists of each Type I CSI reporting in the first N3 CSI reporting(s) in the N CSI reportings.

In one embodiment, the fourth reference CSI reporting subset comprises at least one CSI reporting other than each Type I CSI reporting in the first N3 CSI reporting(s) in the N CSI reportings.

### Embodiment 14

Embodiment 14 illustrates a schematic diagram of N priorities being used to determine a number of CSI reporting(s) comprised in a first CSI reporting subset according to one embodiment of the present application, as shown in FIG. 14. In embodiment 14, at least one Type II CSI reporting in the N CSI reportings corresponds to a first-type integer; the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings and each Type II CSI reporting corresponding to one first-type integer in the first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings. In FIG. 14, indexes of the N CSI reportings are respectively #0, . . . , #(N-1); and the first M3 CSI reporting(s) is(are) CSI reportings indexed as #0, . . . , #(M3-1).

In one embodiment, for any Type II CSI reporting in the N CSI reportings, and if the any Type II CSI reporting occupies at least one the first-type processing unit when it is updated, the any Type II CSI reporting corresponds to a first-type integer, the any Type II CSI reporting, if updated, occupies a number of the first-type processing unit(s) equal to the corresponding first-type integer; if the any Type II CSI reporting does not occupy the first-type processing unit when it is updated, there does not exist a first-type integer corresponding to the any Type II CSI reporting.

In one embodiment, there exists one Type II CSI reporting in the N CSI reportings not having corresponding first-type integer.

In one embodiment, any Type II CSI reporting in the N CSI reportings corresponds to a first-type integer.

In one embodiment, any Type II CSI reporting in the N CSI reportings, regardless of whether it occupies the first-type processing unit when it is updated, corresponds to a first-type integer.

In one subembodiment of the above embodiment, if the any Type II CSI reporting occupies at least the first-type processing unit when it is updated, the first-type integer corresponding to the any Type II CSI reporting is greater than 0; if the any Type II CSI reporting does not occupy the first-type processing unit when it is updated, the first-type integer corresponding to the any Type II CSI reporting is equal to 0.

In one embodiment, the fourth reference CSI reporting subset consists of each Type I CSI reporting in the first N3 CSI reporting(s) in the N CSI reportings, and all Type II CSI reportings corresponding to a first-type integer in the first N3 CSI reporting(s) in the N CSI reportings.

In one embodiment, any CSI reporting in the fourth reference CSI reporting subset corresponds to a first-type integer.

In one embodiment, the fourth reference CSI reporting subset comprises at least one Type II CSI reporting in the first N3 CSI reporting(s) in the N CSI reportings.

In one embodiment, the fourth reference CSI reporting subset does not comprise a Type II CSI reporting in the first N3 CSI reporting(s) in the N CSI reportings.

In one embodiment, the fourth reference CSI reporting subset comprises each Type II CSI reporting in the first N3 CSI reporting(s) in the N CSI reportings.

In one embodiment, the fourth reference CSI reporting subset comprises only partial Type II CSI reporting(s) in the first N3 CSI reporting(s) in the N CSI reportings.

### Embodiment 15

Embodiment 15 illustrates a schematic diagram of whether a Type II CSI reporting corresponds to a first-type integer according to one embodiment of the present application, as shown in FIG. 15. In embodiment 15, at least one Type II CSI reporting in the N CSI reportings corresponds to a first-type integer; a reference CSI reporting is any Type II CSI reporting in the N CSI reportings, and a type of a CSI reporting quantity comprised in the reference CSI reporting is used to determine whether the reference CSI reporting corresponds to a first-type integer.

In one embodiment, when a type of a CSI reporting quantity comprised in the reference CSI reporting belongs to a first-type subset, the reference CSI reporting corresponds to a first-type integer; when types of all CSI reporting quantities comprised in the reference CSI reporting do not belong to the first-type subset, the reference CSI reporting does not have a corresponding first-type integer.

In one embodiment, a type of a CSI reporting quantity comprised in the reference CSI reporting is used to determine whether the reference CSI reporting, if updated, occupies the first-type processing unit.

In one embodiment, when a type of a CSI reporting quantity comprised in the reference CSI reporting belongs to a first-type subset, the reference CSI reporting, is updated, occupies at least the first-type processing unit; when types of all CSI reporting quantities comprised in the reference CSI reporting do not belong to the first-type subset, the reference CSI reporting, if updated, does not occupy the first-type processing unit.

In one embodiment, the first-type subset comprises CQI, PMI, CRI, LI, RI, SSBRI, L1-RSRP, and L1-SINR.

In one embodiment, at least one Type II CSI reporting in the N CSI reportings corresponds to a first-type integer; for any Type II CSI reporting in the N CSI reportings, and if the any Type II CSI reporting corresponds to a first-type integer, a value of the first-type integer corresponding to the any Type II CSI reporting is related to at least one of a type of one or more CSI reporting quantities comprised in the any Type II CSI reporting, whether an associated CSI-RS resource set is configured with a higher-layer parameter “trs-Info”, a number of CSI-RS resources comprised in an associated CSI-RS resource set, a number of CSI-RS port(s) for CSI-RS resources in an associated CSI-RS resource set, or a frequency-domain granularity.

### Embodiment 16

Embodiment 16 illustrates a schematic diagram of a first reference threshold, a second reference threshold, a first threshold and a second threshold according to one embodiment of the present application, as shown in FIG. 16. In embodiment 16, the first reference threshold is equal to a difference of the first threshold and the first integer, and the first integer is a number of first-type processing unit(s) already occupied in the first symbol; the second reference threshold is equal to a difference of the second threshold and a second integer, and the second integer is a number of second-type processing unit(s) already occupied in the first symbol.

In one embodiment, the first reference threshold and the second reference threshold are respectively integers.

In one embodiment, the first reference threshold is dynamically determined.

In one embodiment, the second reference threshold is dynamically determined.

In one embodiment, the first reference threshold is determined per symbol.

In one embodiment, the second reference threshold is determined per symbol.

In one embodiment, the first reference threshold is a number of first-type processing unit(s) not occupied in the first symbol.

In one embodiment, the second reference threshold is a number of the second-type processing unit(s) not occupied in the first symbol.

In one embodiment, the first reference threshold is a number of first-type processing unit(s) not occupied in the first symbol before the first node determines the first CSI reporting subset.

In one embodiment, the second reference threshold is a number of second-type processing unit(s) not occupied in the first symbol before the first node determines the first CSI reporting subset.

In one embodiment, the first threshold and the second threshold are positive integers, respectively.

In one embodiment, the first threshold and the second threshold are positive integers not greater than 8, respectively.

In one embodiment, the first threshold and the second threshold are positive integers not greater than 32, respectively.

In one embodiment, the first threshold and the second threshold are positive integers not greater than 256, respectively.

In one embodiment, a sum of the first threshold and the second threshold is not greater than a third threshold, and the third threshold is a positive integer.

In one embodiment, the third threshold is fixed.

In one embodiment, the third threshold is indicated by the first node.

In one embodiment, the third threshold is configurable.

In one embodiment, the third threshold is related to capability of the first node.

In one embodiment, the third threshold is not greater than 1024.

In one embodiment, the first threshold is a number of first-type processing unit(s) owned by the first node, and the second threshold is a number of second-type processing unit(s) owned by the first node.

In one embodiment, the first threshold is a number of first-type CSI calculation(s) supported by the first node that can be performed simultaneously, and the second threshold is a number of second-type CSI calculation(s) supported by the first node that can be performed simultaneously.

In one embodiment, the N CSI reportings are for a same component carrier, the first threshold is a number of the first-type processing unit(s) owned by the first node on the same component carrier, and the second threshold is a number of the second-type processing unit(s) owned by the first node on the same component carrier.

In one embodiment, the N CSI reportings are for a same component carrier, the first threshold is a number of first-type CSI calculation(s) supported by the first node on the same component carrier that can be performed simultaneously, and the second threshold is a number of second-type CSI calculation(s) supported by the first node on the same component carrier that can be performed simultaneously.

In one embodiment, there exist two CSI reportings in the N CSI reportings targeting different component carriers, the first threshold is a number of first-type processing unit(s) owned by the first node on all component carriers, and the second threshold is a number of second-type processing unit(s) owned by the first node on all component carriers.

In one embodiment, there exist two CSI reportings in the N CSI reportings targeting different component carriers, the first threshold is a number of first-type CSI calculation(s) supported by the first node on all component carriers that can be performed simultaneously, and the second threshold is a number of second-type CSI calculation(s) supported by the first node on all component carriers that can be performed simultaneously.

In one embodiment, the first-type CSI calculation comprises any one or more calculations of CRI, SSBRI, L1-RSRP, L1-SINR, RI, CQI, PMI, or LI.

In one embodiment, the first-type CSI calculation comprises a calculation for a CSI reporting quantity whose type belonging to a first-type subset; the first-type subset comprises CQI, PMI, CRI, LI, RI, SSBRI, L1-RSRP, and L1-SINR.

In one embodiment, the second-type CSI calculation comprises AI-based CSI calculation.

In one embodiment, the second-type CSI calculation comprises a calculation of a compressed CSI.

In one embodiment, the second-type CSI calculation comprises an encoding process based on CsiNet or CRNet

In one embodiment, the second-type CSI calculation comprises CNN-based CSI compression.

In one embodiment, the second-type CSI calculation comprises a calculation of compressed CSI, or any one or more calculations of a calculation of compressed CSI and CRI, SSBRI, L1-RSRP, L1-SINR, RI, CQI, PMI, or LI.

In one embodiment, the second-type CSI calculation comprises an encoding process based on CsiNet or CRNet, or any one or more calculations of an encoding process based on CsiNet or CRNet and CRI, SSBRI, L1-RSRP, L1-SINR, RI, CQI, PMI, or LI.

In one embodiment, the second-type CSI calculation comprises a calculation for a CSI reporting quantity whose type belonging to a second-type subset; the second-type subset comprises a compressed CSI.

In one embodiment, the first-type processing unit is used for only the first-type CSI calculation in the first-type CSI calculation and the second-type CSI calculation; the second-type processing unit is used for only the second-type CSI calculation in the first-type CSI calculation and the second-type CSI calculation.

In one embodiment, the first-type processing unit is used for only the first-type CSI calculation in the first-type CSI calculation and the second-type CSI calculation; the second-type processing unit is used for the first-type CSI calculation and the second-type CSI calculation.

In one embodiment, the first-type processing unit is a CSI processing unit used for the first-type CSI calculation.

In one embodiment, the second-type processing unit is a CSI processing unit used for the second-type CSI calculation.

In one embodiment, the second-type processing unit is a CSI processing unit used for the first-type CSI calculation and the second-type CSI calculation.

In one embodiment, the second-type processing unit is a processing unit used for an encoder based on CsiNet or CRNet.

In one embodiment, for a detailed description of CsiNet, refer to Chao-Kai Wen, Deep Learning for Massive CSI Feedback, 2018 IEEE Wireless Communications Letters, vol. 7 No. 5. October 2018 et al.

In one embodiment, for a detailed description of CRNet, refer to Zhilin Lu. Multi-resolution CSI Feedback with Deep Learning in Massive MIMO System, 2020 IEEE International Conference on Communications (ICC) et al.

In one embodiment, the first integer and the second integer are non-negative integers, respectively.

In one embodiment, the first integer is a number of first-type processing unit(s) of the first node that have already been occupied in the first symbol.

In one embodiment, the first integer is a number of first-type processing unit(s) used for the first-type CSI calculation that have already been occupied in the first symbol.

In one embodiment, the first integer is a number of first-type processing unit(s) that have been occupied in the first symbol before the first node determines the first CSI reporting subset.

In one embodiment, the N CSI reportings are for a same component carrier, and the first integer is a number of first-type processing unit(s) already occupied on the same component carrier in the first symbol.

In one embodiment, there exist two CSI reportings in the N CSI reportings being for different component carriers, and the first integer is a number of first-type processing unit(s) that have already been occupied on all component carriers in the first symbol.

In one embodiment, the second integer is a number of second-type processing unit(s) of the first node that have already been occupied in the first symbol.

In one embodiment, the second integer is a number of second-type processing unit(s) used for the second-type CSI calculation that have already been occupied in the first symbol.

In one embodiment, the second integer is a number of second-type processing unit(s) used for the first-type CSI calculation and the second-type CSI calculation that have already been occupied in the first symbol.

In one embodiment, the second integer is a number of second-type processing unit(s) that have been occupied in the first symbol before the first node determines the first CSI reporting subset.

In one embodiment, the N CSI reportings are for a same component carrier, and the second integer is a number of second-type processing unit(s) already occupied on the same component carrier in the first symbol.

In one embodiment, there exist two CSI reportings in the N CSI reportings being for different component carriers, and the second integer is a number of second-type processing unit(s) that have already been occupied on all component carriers in the first symbol.

In one embodiment, the first-type processing unit that has already been occupied in the first symbol is occupied from before the first symbol.

In one embodiment, the second-type processing unit that has already been occupied in the first symbol is occupied from before the first symbol.

### Embodiment 17

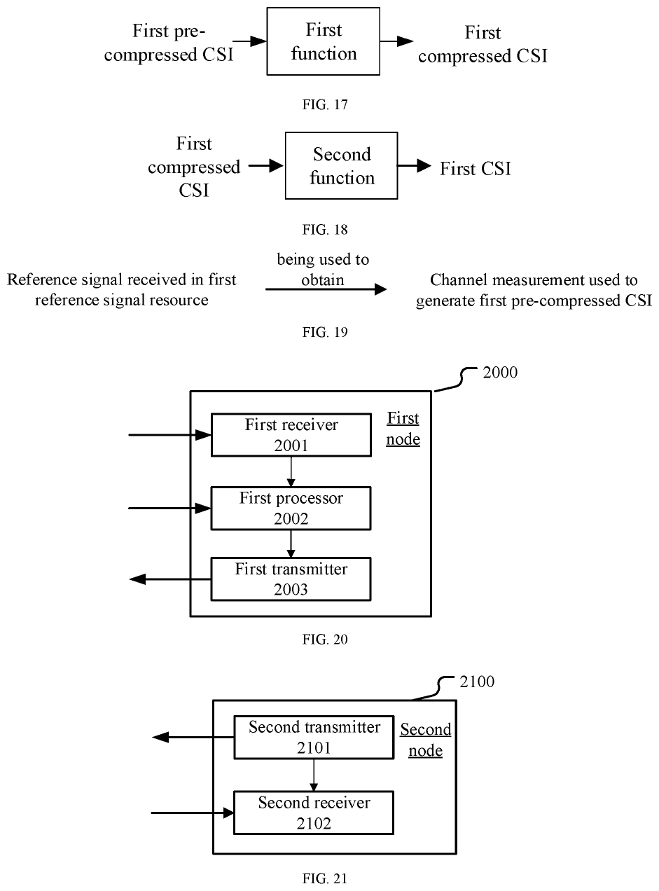

Embodiment 17 illustrates a schematic diagram of a relation between a first pre-compressed CSI and a first compressed CSI according to one embodiment of the present application, as shown in FIG. 17. In embodiment 17, the first information block comprises a first CSI reporting, and the first CSI reporting is a Type II CSI reporting in the first CSI reporting subset; the first CSI reporting comprises the first compressed CSI, and the pre-compressed CSI being used as an input to the first function is used to generate the first compressed CSI.

In one embodiment, the first compressed CSI comprises a PMI.

In one embodiment, the first compressed CSI comprises one or multiple of a CQI, a CRI or an RI.

In one embodiment, the first compressed CSI comprises a matrix.

In one embodiment, the first compressed CSI comprises a vector.

In one embodiment, the first compressed CSI comprises information of a channel matrix.

In one embodiment, the first compressed CSI comprises amplitude and phase information of elements in a channel matrix.

In one embodiment, the first pre-compressed CSI comprises amplitude and phase information of elements in a channel matrix.

In one embodiment, the first pre-compressed CSI comprises a channel matrix.

In one embodiment, the first pre-compressed CSI is obtained by mathematically transforming a channel matrix.

In one embodiment, the mathematical transformation comprises Discrete Fourier Transform (DFT).

In one embodiment, the mathematical transformation comprises one or more of quantization, transformation from spatial domain to angle domain, transformation from frequency domain to time domain, or truncation.

In one embodiment, the first pre-compressed CSI consists of Q1 bits, the first compressed CSI consists of Q2 bits, Q1 and Q2 respectively being positive integers greater than 1, Q1 being greater than the Q2.

In one embodiment, the first function is non-linear.

In one embodiment, the first function comprises a neural network.

In one embodiment, the first function comprises a neural network used for CSI compression.

In one embodiment, the first function comprises an encoder for a neural network for CSI compression.

In one embodiment, the first function comprises K1 sub-functions, K1 being a positive integer greater than 1; the K1 sub-functions comprise one or more of convolutional function, pooling function, cascading function, or activation function.

In one embodiment, the first function comprises K1 parameter sub-groups, and the K1 parameter sub-groups are respectively used for the K1 sub-functions; the K1 parameter subgroups comprises one or multiple of a convolution kernel, pooling function, parameters of pooling function, activation function, a threshold of activation function, weights between feature maps.

In one embodiment, there exists one of the K1 sub-functions comprising fully-connected layer.

In one embodiment, there exists one of the K1 sub-functions comprising a pooling layer.

In one embodiment, there exists one of the K1 sub-functions comprising at least one convolutional layer.

In one embodiment, there exists one of the K1 sub-functions comprising at least one encoding layer.

In one embodiment, there exist two sub-functions in the K1 sub-functions respectively comprising a fully-connected layer and at least one encoding layer.

In one embodiment, an encoding layer comprise at least one convolutional layer and one pooling layer.

In one embodiment, the first function is indicated to the first node by a target receiver of the first information block.

In one embodiment, the first function is determined by the first node itself.

### Embodiment 18

Embodiment 18 illustrates a schematic diagram of a first compressed CSI according to one embodiment of the present application, as shown in FIG. 18. In embodiment 18, the first compressed CSI being used as an input of a second function is used by a target receiver of the first information block to generate a first CSI.

In one embodiment, the first CSI comprises an estimation value of the first pre-compressed CSI.

In one embodiment, the first CSI comprises a PMI.

In one embodiment, the first CSI comprises one or multiple of a CQI, a CRI or an RI.

In one embodiment, the first CSI comprises a channel matrix.

In one embodiment, the first CSI comprises amplitude and phase information of elements in a channel matrix.

In one embodiment, the first CSI comprises information of a channel matrix.

In one embodiment, the first function is used to compress the first pre-compressed CSI to reduce the radio overhead of the first compressed CSI, and the second function is used to decompress the first compressed CSI to recover the first pre-compressed CSI as much as possible.

In one embodiment, the second function is an inverse function of the first function.

In one embodiment, encoders and decoders based on CsiNet or CRNet are respectively used to implement the first function and the second function.

### Embodiment 19

Embodiment 19 illustrates a schematic diagram of a first node obtaining a channel measurement used for generating a first pre-compressed CSI based on a reference signal received in a first reference signal resource according to one embodiment of the present application, as shown in FIG. 19.

In one embodiment, the first reference signal resources comprise CSI-RS resources or SS/PBCH Block resources.

In one embodiment, the first reference signal resource comprises a DMRS port.

In one embodiment, the first reference signal resource is associated with the first function.

In one subembodiment of the above embodiment, a measurement for a reference signal received in the first reference signal resource is used to generate an input of the first function.

In one subembodiment of the above embodiment, the first node obtains a channel measurement used to calculate an input of the first function based on a reference signal received in the first reference signal resource.

In one subembodiment of the above embodiment, the first function is used to compress a CSI obtained based on a channel measurement for a reference signal received in the first reference signal resource.

In one embodiment, the first node receives indication information from a target receiver of the first information block indicating that the first reference signal resource is associated with the first function.

In one embodiment, the first node obtains a first channel matrix based on a reference signal received in the first reference signal resource, and any element in the first channel matrix represents a channel to which a radio signal transmitted on an RS port of the first reference signal resource on a frequency unit is subjected; the first channel matrix is used to generate the first pre-compressed CSI.

In one embodiment, the first CSI comprises amplitude and phase information of elements in the first channel matrix.

In one embodiment, the first CSI comprises an estimate value of the first channel matrix.

In one embodiment, the first pre-compressed CSI comprises amplitude and phase information of elements in the first channel matrix.

In one embodiment, the first pre-compressed CSI comprises the first channel matrix.

In one embodiment, the first pre-compressed CSI is obtained by mathematically transforming the first channel matrix.

In one embodiment, the frequency unit is a subcarrier.

In one embodiment, the frequency unit is a Physical Resource Block (PRB).

In one embodiment, the frequency unit consists of multiple continuous subcarriers.

In one embodiment, the frequency unit consists of multiple continuous PRBs.

In one embodiment, the reception of a reference signal in the first reference signal resource occurs before determining the first CSI reporting subset.

In one embodiment, the reception of a reference signal in the first reference signal resource occurs after determining the first CSI reporting subset.

### Embodiment 20

Embodiment 20 illustrates a structure block diagram of a processor in a first node according to one embodiment of the present application, as shown in FIG. 20. In FIG. 20, a processor 2000 in a first node comprises a first receiver 2001, a first processor 2002 and a first transmitter 2003.

In embodiment 20, the first receiver 2001 receives N CSI configuration information, the N CSI configuration information is respectively used to determine N CSI reportings, the N CSI reportings do not occupy a first-type processing unit and a second-type processing unit before a first symbol, N being a positive integer greater than 1; the first processor 2002 updates a CSI reporting in a first CSI reporting subset, and the first CSI reporting subset is a subset of the N CSI reportings; the first transmitter 2003 transmits a first information block, and the first information block comprises at least one CSI reporting of the N CSI reportings.

In embodiment 20, any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; the first node determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

In one embodiment, the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

In one embodiment, at least one Type II CSI reporting in the N CSI reportings corresponds to a first-type integer; the first reference CSI reporting subset also comprises each Type II CSI reporting corresponding to one first-type integer in the first N1 CSI reporting(s) in the N CSI reportings; the second condition set also comprises a third condition, the third condition comprises that a sum of the first-type integer(s) corresponding to all CSI reporting(s) in a third reference CSI reporting subset is not greater than the first reference threshold, and the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings,

In one embodiment, the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings.

In one embodiment, at least one Type II CSI reporting in the N CSI reportings corresponds to a first-type integer; the fourth reference CSI reporting subset also comprises each Type II CSI reporting corresponding to one first-type integer in the first N3 CSI reporting(s) in the N CSI reportings;

In one embodiment, the first transmitter 2003 transmits a second information block; herein, the second information block indicates a first threshold and a second threshold; the first reference threshold is equal to a difference of the first threshold and a first integer, and the first integer is a number of first-type processing unit(s) already occupied in the first symbol; the second reference threshold is equal to a difference of the second threshold and a second integer, and the second integer is a number of second-type processing unit(s) already occupied in the first symbol.

In one embodiment, the first information block comprises a first CSI reporting, and the first CSI reporting is a Type II CSI reporting in the first CSI reporting subset; the first CSI reporting comprises a first compressed CSI, and a first pre-compressed CSI used as an input to a first function is used to generate the first compressed CSI.

In one embodiment, the first processor 2002 determines the first CSI reporting subset.

In one embodiment, the first processor 2002 updates at least one CSI reporting not belonging to the first CSI reporting subset in the N CSI reportings.

In one embodiment, the first processor 2002 receives a reference signal in a first reference signal resource; herein, the first node obtains a channel measurement used for generating the first pre-compressed CSI based on a reference signal received in the first reference signal resource.

In one embodiment, the first node is a UE.

In one embodiment, the first node is a relay node.

In one embodiment, the N CSI configuration information is carried by N IEs, and names of N IEs all comprise “CSI-ReportConfig”; the N CSI reportings are respectively one CSI reporting for the N CSI configuration information; the first information block comprises a CSI; there exist two CSI reportings in the N CSI reportings being respectively a Type I CSI reporting and a Type II CSI reporting; the first-type integer is a non-negative integer, and the second-type integer is a non-negative integer.

In one embodiment, the first-type processing unit comprises a CSI processing unit used for a first-type CSI calculation, where the first-type CSI calculation comprises any one or more calculations of CRI, SSBRI, L1-RSRP, L1-SINR, RI, CQI, PMI, LI; the second-type processing unit comprises a processing unit used for a second-type CSI calculation.

In one subembodiment of the above embodiment, the second-type CSI calculation comprises a calculation of a compressed CSI.

In one subembodiment of the above embodiment, the second-type CSI calculation comprises an encoding process based on CsiNet or CRNet.

In one embodiment, the first receiver 2001 comprises at least one of the antenna 452, the receiver 454, the receiving processor 456, the multi-antenna receiving processor 458, the controller/processor 459, the memory 460, or the data source 467 in Embodiment 4.

In one embodiment, the first processor 2002 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 2003 comprises at least one of the antenna 452, the transmitter 454, the transmitting processor 468, the multi-antenna transmitting processor 457, the controller/processor 459, the memory 460, or the data source 467 in Embodiment 4.

### Embodiment 21

Embodiment 21 illustrates a structure block diagram of a processor in a second node according to one embodiment of the present application, as shown in FIG. 21. In FIG. 21, the processor 2100 in a second node comprises a third transmitter 2101 and a second receiver 2102.

In embodiment 21, the second transmitter 2101 transmits N CSI configuration information, the N CSI configuration information is respectively used to determine N CSI reportings, the N CSI reportings do not occupy a first-type processing unit and a second-type processing unit before a first symbol, N being a positive integer greater than 1; the second receiver 2102 receives a first information block, the first information block comprises at least one CSI reporting in the N CSI reportings.

In embodiment 21, any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; a transmitter of the first information block updates a CSI reporting in a first CSI reporting subset, the first CSI reporting subset is a subset of the N CSI reportings; the transmitter of the first information block determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

In one embodiment, the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

In one embodiment, at least one Type II CSI reporting in the N CSI reportings corresponds to a first-type integer; the first reference CSI reporting subset also comprises each Type II CSI reporting corresponding to one first-type integer in the first N1 CSI reporting(s) in the N CSI reportings; the second condition set also comprises a third condition, the third condition comprises that a sum of the first-type integer(s) corresponding to all CSI reporting(s) in a third reference CSI reporting subset is not greater than the first reference threshold, and the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings.

In one embodiment, the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings.

In one embodiment, at least one Type II CSI reporting in the N CSI reportings corresponds to a first-type integer; the fourth reference CSI reporting subset also comprises each Type II CSI reporting corresponding to one first-type integer in the first N3 CSI reporting(s) in the N CSI reportings;

In one embodiment, the second receiver 2102 receives a second information block; herein, the second information block indicates a first threshold and a second threshold; the first reference threshold is equal to a difference of the first threshold and a first integer, and the first integer is a number of first-type processing unit(s) already occupied in the first symbol; the second reference threshold is equal to a difference of the second threshold and a second integer, and the second integer is a number of second-type processing unit(s) already occupied in the first symbol.

In one embodiment, the first information block comprises a first CSI reporting, and the first CSI reporting is a Type II CSI reporting in the first CSI reporting subset; the first CSI reporting comprises a first compressed CSI, and a first pre-compressed CSI used as an input to a first function is used to generate the first compressed CSI.

In one embodiment, the second transmitter 2101 transmits a reference signal in a first reference signal resource; herein, the transmitter of the first information block obtains a channel measurement used for generating the first pre-compressed CSI based on a reference signal received in the first reference signal resource.

In one embodiment, a device in the second node is a base station.

In one embodiment, a device in the second node is a UE.

In one embodiment, a device in the second node is a relay node.

In one embodiment, the N CSI configuration information is respectively carried by N IEs, and names of N IEs all comprise “CSI-ReportConfig”; the N CSI reportings are respectively one CSI reporting for the N CSI configuration information; the first information block comprises a CSI; there exist two CSI reportings in the N CSI reportings being respectively a Type I CSI reporting and a Type II CSI reporting; the first-type integer is a non-negative integer, and the second-type integer is a non-negative integer.

In one embodiment, the first-type processing unit comprises a CSI processing unit used for a first-type CSI calculation, where the first-type CSI calculation comprises any one or more calculations of CRI, SSBRI, L1-RSRP, L1-SINR, RI, CQI, PMI, LI; the second-type processing unit comprises a processing unit used for a second-type CSI calculation.

In one subembodiment of the above embodiment, the second-type CSI calculation comprises a calculation of a compressed CSI.

In one subembodiment of the above embodiment, the second-type CSI calculation comprises an encoding process based on CsiNet or CRNet.

In one embodiment, the second transmitter 2101 comprises at least one of the antenna 420, the transmitter 418, the transmitting processor 416, the multi-antenna transmitting processor 471, the controller/processor 475, or the memory 476 in Embodiment 4.

In one embodiment, the second receiver 2102 comprises at least one of the antenna 420, the receiver 418, the receiving processor 470, the multi-antenna receiving processor 472, the controller/processor 475, the memory 476 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, tele-controlled aircrafts, aircrafts, diminutive airplanes, mobile phones, tablet computers, notebooks, vehicle-mounted communication equipment, vehicles, cars, RSUs, wireless sensors, network cards, Internet of Things (IOT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving N CSI configuration information, the N CSI configuration information being respectively used to determine N CSI reportings, the N CSI reportings not occupying a first-type processing unit and a second-type processing unit before a first symbol, N being a positive integer greater than 1;
a first processor, updating a CSI reporting in a first CSI reporting subset, the first CSI reporting subset being a subset of the N CSI reportings; and
a first transmitter, transmitting a first information block, the first information block comprising at least one CSI reporting of the N CSI reportings;
wherein any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; the first node determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

2. The first node according to claim 1, wherein the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

3. The first node according to claim 2, wherein at least one Type II CSI reporting in the N CSI reportings corresponds to a first-type integer; the first reference CSI reporting subset also comprises each Type II CSI reporting corresponding to one first-type integer in the first N1 CSI reporting(s) in the N CSI reportings; the second condition set also comprises a third condition, the third condition comprises that a sum of the first-type integer(s) corresponding to all CSI reporting(s) in a third reference CSI reporting subset is not greater than the first reference threshold, and the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings.

4. The first node according to claim 1, wherein the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings.

5. The first node according to claim 4, wherein at least one Type II CSI reporting in the N CSI reportings corresponds to a first-type integer; the fourth reference CSI reporting subset also comprises each Type II CSI reporting corresponding to one first-type integer in the first N3 CSI reporting(s) in the N CSI reportings.

6. The first node according to claim 2, wherein the first transmitter transmits a second information block; wherein the second information block indicates a first threshold and a second threshold; the first reference threshold is equal to a difference of the first threshold and a first integer, and the first integer is a number of first type processing unit(s) already occupied in the first symbol; the second reference threshold is equal to a difference of the second threshold and a second integer, and the second integer is a number of second type processing unit(s) already occupied in the first symbol.

7. The first node according to claim 1, wherein the first information block comprises a first CSI reporting, and the first CSI reporting is a Type II CSI reporting in the first CSI reporting subset; the first CSI reporting comprises a first compressed CSI, and a first pre-compressed CSI used as an input to a first function is used to generate the first compressed CSI.

8. A second node for wireless communications, comprising:
a second transmitter, transmitting N CSI configuration information, the N CSI configuration information being respectively used to determine N CSI reportings, the N CSI reportings not occupying a first-type processing unit and a second-type processing unit before a first symbol, N being a positive integer greater than 1; and
a second receiver, receiving a first information block, the first information block comprising at least one CSI reporting of the N CSI reportings;
wherein any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; a transmitter of the first information block updates a CSI reporting in a first CSI reporting subset, the first CSI reporting subset is a subset of the N CSI reportings; the transmitter of the first information block determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

9. The second node according to claim 8, wherein the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

10. The second node according to claim 9, wherein at least one Type II CSI reporting in the N CSI reportings corresponds to a first-type integer; the first reference CSI reporting subset also comprises each Type II CSI reporting corresponding to one first-type integer in the first N1 CSI reporting(s) in the N CSI reportings; the second condition set also comprises a third condition, the third condition comprises that a sum of the first-type integer(s) corresponding to all CSI reporting(s) in a third reference CSI reporting subset is not greater than the first reference threshold, and the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings.

11. The second node according to claim 8, wherein the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings;
or, the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings; at least one Type II CSI reporting in the N CSI reportings corresponds to a first-type integer; the fourth reference CSI reporting subset also comprises each Type II CSI reporting corresponding to one first-type integer in the first N3 CSI reporting(s) in the N CSI reportings.

12. The second node according to claim 9, wherein the second receiver receives a second information block; wherein the second information block indicates a first threshold and a second threshold; the first reference threshold is equal to a difference of the first threshold and a first integer, and the first integer is a number of first type processing unit(s) already occupied in the first symbol; the second reference threshold is equal to a difference of the second threshold and a second integer, and the second integer is a number of second type processing unit(s) already occupied in the first symbol.

13. The second node according to claim 8, wherein the first information block comprises a first CSI reporting, and the first CSI reporting is a Type II CSI reporting in the first CSI reporting subset; the first CSI reporting comprises a first compressed CSI, and a first pre-compressed CSI used as an input to a first function is used to generate the first compressed CSI.

14. A method in a first node for wireless communications, comprising:
receiving N CSI configuration information, the N CSI configuration information being respectively used to determine N CSI reportings, the N CSI reportings not occupying a first-type processing unit and a second-type processing unit before a first symbol, N being a positive integer greater than 1;
updating a CSI reporting in a first CSI reporting subset, the first CSI reporting subset being a subset of the N CSI reportings; and
transmitting a first information block, the first information block comprising at least one CSI reporting of the N CSI reportings;
wherein any one of the N CSI reportings is a Type I CSI reporting or a Type II CSI reporting; any Type I CSI reporting in the N CSI reportings corresponds to a first-type integer, and any Type II CSI reporting in the N CSI reportings corresponds to a second-type integer; any Type I CSI reporting in the N CSI reportings, if updated, does not occupy the second-type processing unit and occupies a number of the first-type processing unit(s) equal to the corresponding first-type integer; any Type II CSI reporting in the N CSI reportings, if updated, occupies a number of the second-type processing unit(s) equal to the corresponding second-type integer; the first node determines on its own whether to update a CSI reporting not belonging to the first CSI reporting subset in the N CSI reportings; the N CSI reportings respectively correspond to N priorities, and the N CSI reportings are sequentially arranged according to corresponding priorities in a descending order; the N priorities are used to determine a number of CSI reporting(s) comprised in the first CSI reporting subset.

15. The method according to claim 14, wherein the first CSI reporting subset comprises a first reporting subgroup and a second reporting subgroup; the first reporting subgroup comprises each Type I CSI reporting in first M1 CSI reporting(s) in the N CSI reportings, M1 is a maximum value of N1 satisfying a first condition, and N1 is a positive integer not greater than the N, the first condition comprises that a sum of the first-type integer(s) corresponding to all CSI reporting(s) in a first reference CSI reporting subset is not greater than a first reference threshold, and the first reference CSI reporting subset comprises each Type I CSI reporting in first N1 CSI reporting(s) in the N CSI reportings; the second reporting subgroup comprises each Type II CSI reporting in first M2 CSI reporting(s) in the N CSI reportings, M2 is a maximum value of N2 satisfying a second condition set, N2 is a positive integer not greater than the N, the second condition set comprises a second condition, the second condition comprises that a sum of the second-type integer(s) corresponding to all CSI reporting(s) in a second reference CSI reporting subset is not greater than a second reference threshold, and the second reference CSI reporting subset comprises each Type II CSI reporting in first N2 CSI reporting(s) in the N CSI reportings.

16. The method according to claim 15, wherein at least one Type II CSI reporting in the N CSI reportings corresponds to a first-type integer; the first reference CSI reporting subset also comprises each Type II CSI reporting corresponding to one first-type integer in the first N1 CSI reporting(s) in the N CSI reportings; the second condition set also comprises a third condition, the third condition comprises that a sum of the first-type integer(s) corresponding to all CSI reporting(s) in a third reference CSI reporting subset is not greater than the first reference threshold, and the third reference CSI reporting subset comprises each Type I CSI reporting in the first N2 CSI reporting(s) in the N CSI reportings and each Type II CSI reporting corresponding to one first-type integer in the first N2 CSI reporting(s) in the N CSI reportings.

17. The method according to claim 14, wherein the first CSI reporting subset consists of first M3 CSI reporting(s) in the N CSI reportings; M3 is a maximum value of N3 satisfying a fourth condition and a fifth condition at the same time, and N3 is a positive integer not greater than N; the fourth condition comprises that a sum of the first-type integer(s) corresponding to all CSI reporting(s) in a fourth reference CSI reporting subset is not greater than a first reference threshold, and the fourth reference CSI reporting subset comprises each Type I CSI reporting in first N3 CSI reporting(s) in the N CSI reportings; the fifth condition comprises that a sum of the second-type integer(s) corresponding to all CSI reporting(s) in a fifth reference CSI reporting subset is not greater than a second reference threshold, and the fifth reference CSI reporting subset consists of each Type II CSI reporting in the first N3 CSI reporting(s) in the N CSI reportings.

18. The method according to claim 17, wherein at least one Type II CSI reporting in the N CSI reportings corresponds to a first-type integer; the fourth reference CSI reporting subset also comprises each Type II CSI reporting corresponding to one first-type integer in the first N3 CSI reporting(s) in the N CSI reportings.

19. The method according to claim 15, comprising:
transmitting a second information block;
wherein the second information block indicates a first threshold and a second threshold; the first reference threshold is equal to a difference of the first threshold and a first integer, and the first integer is a number of first type processing unit(s) already occupied in the first symbol; the second reference threshold is equal to a difference of the second threshold and a second integer, and the second integer is a number of second type processing unit(s) already occupied in the first symbol.

20. The method according to claim 14, wherein the first information block comprises a first CSI reporting, and the first CSI reporting is a Type II CSI reporting in the first CSI reporting subset; the first CSI reporting comprises a first compressed CSI, and a first pre-compressed CSI used as an input to a first function is used to generate the first compressed CSI.
